(19) United States
(12) Patent Application Publication
(10) Pub. No.: US 2024/0241222 A1
(43) Pub. Date: Jul. 18, 2024

(54) Cooperative Bistatic Radar Sensing Using Deep Neural Networks

(71) Applicant: Google LLC, Mountain View, CA (US)

(72) Inventors: Jibing Wang, San Jose, CA (US); Erik Richard Stauffer, Sunnyvale, CA (US)

(21) Appl. No.: 18/557,849

(22) PCT Filed: May 2, 2022
(86) PCT No.: PCT/US2022/072047

§ 371 Date: Oct. 27, 2023

Related U.S. Application Data
(60) Provisional application No. 63/183,514, filed on May 3, 2021.

(51) Int. Cl. G01S 7/41; G01S 13/00

(52) U.S. Cl. CPC G01S 7/417; G01S 7/411; G01S 13/003

(57) ABSTRACT

Techniques and apparatuses are described that implement cooperative bistatic radar sensing using deep neural networks. In particular, a base station (120) operates as a transmitter of the bistatic radar, and the user equipment (110) operates as a receiver of the bistatic radar. During radar sensing, the base station (120) and the user equipment (110) use their respective deep neural networks (460 and 420) for signal generation and signal processing. The deep neural networks (460 and 420) also enable the base station (120) and the user equipment (110) to utilize the same hardware for both radar sensing and wireless communication. With cooperative bistatic radar sensing, the base station (120) and the user equipment (110) can compile explicit information about objects within an operating environment and use this information to improve wireless communication performance.

### BACKGROUND

Evolving wireless communication systems utilize increasingly complex architectures as a way to provide more performance relative to preceding wireless communication systems. As one example, fifth generation new radio (5G NR) wireless technologies transmit data using higher frequency ranges, such as the above-6 gigahertz. (GHz) band or the terahertz. (THz) band, to increase data capacity. However, transmitting and recovering information using these higher frequency ranges poses challenges. To illustrate, higher-frequency signals are more susceptible to multipath fading, scattering, atmospheric absorption, diffraction, and interference, relative to lower frequency signals. As another example, hardware capable of transmitting, receiving, routing, and/or otherwise using these higher frequencies can be expensive and complicated to incorporate into portable electronic devices.

### SUMMARY

Techniques and apparatuses are described that implement cooperative bistatic radar sensing using deep neural networks. In particular, a base station and a user equipment include a pair of deep neural networks, which are jointly trained to enable cooperative bistatic radar sensing. The base station operates as a transmitter of the bistatic radar, and the user equipment operates as a receiver of the bistatic radar. During cooperative bistatic radar sensing, the base station and the user equipment use their respective deep neural networks for signal generation and signal processing. The deep neural networks also enable the base station and the user equipment to utilize the same hardware (e.g., antennas, radio-frequency front ends, and transceivers) for both radar sensing and wireless communication. As such, the base station and user equipment can perform radar sensing without the use of dedicated radar sensors. In some implementations, the deep neural networks enable concurrent radar sensing and cellular reference and/or data signaling, which enables efficient use of a frequency spectrum. With cooperative bistatic radar sensing, the base station and the user equipment can compile explicit information about objects within an operating environment and use this information to improve wireless communication performance.

In aspects, a first device operates as a radar signal receiver of a bistatic radar. In particular, the first device receives a reflected version of a radar signal. The radar signal is transmitted by a second device and reflected off an object. The first device generates radar data by processing the reflected version of the radar signal using a deep neural network. The radar data includes information about the object. Additionally, the first device operates as a feedback signal transmitter. In particular, the first device generates a feedback signal using the deep neural network. The feedback signal is based on the radar data. Furthermore, the first device transmits the feedback signal to the second device.

In aspects, a first device operates as a radar signal transmitter of a bistatic radar. In particular, the first device generates a radar signal using a deep neural network. The first device transmits the radar signal, which reflects off an object. Additionally, the first device operates as a feedback signal receiver. In particular, the first device receives a feedback signal from a second device. The feedback signal indicates radar data generated by the second device based on the radar signal. Furthermore, the first device determines information about the object by processing the radar data using the deep neural network.

Aspects described below also include a system with means for cooperative bistatic radar sensing using deep neural networks.

### BRIEF DESCRIPTION OF DRAWINGS

Apparatuses for and techniques implementing cooperative bistatic radar sensing using deep neural networks are described with reference to the following drawings. The same numbers are used throughout the drawings to reference like features and components:

FIG. 1 illustrates example environments in which various aspects of cooperative bistatic radar sensing using deep neural networks can be implemented;

FIG. 2 illustrates an example environment in which various aspects of cooperative bistatic radar sensing using deep neural networks can be implemented;

FIG. 3 illustrates example signals for cooperative bistatic radar sensing using deep neural networks;

FIG. 4 illustrates an example device diagram of devices that can implement various aspects of cooperative bistatic radar sensing using deep neural networks;

FIG. 5 illustrates an example of generating multiple neural network formation configurations in accordance with cooperative bistatic radar sensing using deep neural networks;

FIG. 6-1 illustrates example operations of a radar signal transmitter and a radar signal receiver for cooperative bistatic radar sensing using deep neural networks;

FIG. 6-2 illustrates example operations of a feedback signal transmitter and a feedback signal receiver for cooperative bistatic radar sensing using deep neural networks;

FIG. 7-1 illustrates example operations of a multipurpose signal transmitter and a multipurpose signal receiver for concurrent cooperative bistatic radar sensing and wireless communication using deep neural networks;

FIG. 7-2 illustrates other example operations of a multipurpose feedback signal transmitter and a multipurpose feedback signal receiver for concurrent bistatic radar sensing and wireless communication using deep neural networks;

FIG. 8 illustrates an example transaction diagram between various network entities that implement cooperative bistatic radar sensing using deep neural networks;

FIG. 9 illustrates an example method for performing operations of cooperative bistatic radar sensing using deep neural networks; and

FIG. 10 illustrates another example method for performing operations of cooperative bistatic radar sensing using deep neural networks.

### DETAILED DESCRIPTION

### Overview

Channel estimation techniques can improve wireless communication performance in the presence of challenging environmental conditions described in the Background section. For example, a base station and user equipment can use channel estimation to determine beamforming configurations that increase signal-to-noise ratios. Channel estimation techniques, however, provide information about the operating environment in an indirect, composite manner. Consequently, explicit (e.g., direct) information about the operating environment (e.g., information about objects within the environment) are still unknown.

In contrast, techniques for cooperative bistatic radar sensing using deep neural networks provide direct information about objects affecting the communication channel. In particular, a base station and a user equipment include a pair of deep neural networks, which are jointly trained to enable cooperative bistatic radar sensing. The base station operates as a transmitter of the bistatic radar, and the user equipment operates as a receiver of the bistatic radar. During cooperative bistatic radar sensing, the base station and the user equipment use their respective deep neural networks for signal generation and signal processing. The deep neural networks also enable the base station and the user equipment to utilize the same hardware (e.g., antennas, radio-frequency front ends, and transceivers) for both radar sensing and wireless communication. As such, the base station and user equipment can perform radar sensing without the use of dedicated radar sensors. In some implementations, the deep neural networks enable concurrent radar sensing and cellular data and/or reference signaling, which enables efficient use of a frequency spectrum. With cooperative bistatic radar sensing, the base station and the user equipment can compile explicit information about objects within the operating environment and use this information to improve wireless communication performance.

### Example Environment

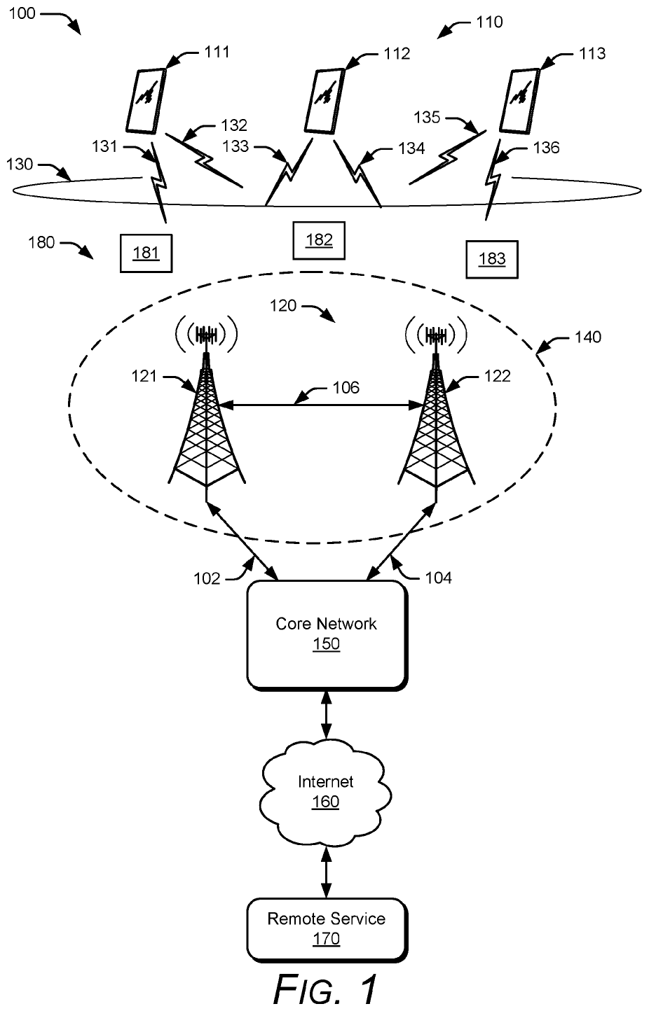

FIG. 1 illustrates an example environment 100, which includes multiple user equipment 110 (UE 110), illustrated as UE 111. UE 112, and UE 113. Each user equipment 110 can communicate with one or more base stations 120 (illustrated as base stations 121 and 122) through one or more wireless communication links 130 (wireless link 130), illustrated as wireless link 131, wireless link 132, wireless link 133, wireless link 134, wireless link 135, and wireless link 136. For simplicity, the user equipment 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IOT) device such as a sensor or an actuator. The base stations 120 (e.g., an Evolved Universal Terrestrial Radio Access Network Node B, E-UTRAN Node B, evolved Node B, eNodeB, eNB. Next Generation Node B, gNode B, gNB, ng-eNB, or the like) may be implemented in a macrocell, microcell, small cell, picocell, distributed base station, and the like, or any combination thereof.

The base stations 120 communicate with the user equipment 110 using the wireless links 130, which may be implemented as any suitable type of wireless link. The wireless links 130 include control and data communication, such as downlink of data and control information communicated from the base stations 120 to the user equipment 110, uplink of other data and control information communicated from the user equipment 110 to the base stations 120, or both. The wireless links 130 may include one or more wireless links (e.g., radio links) or bearers implemented using any suitable communication protocol or standard, or combination of communication protocols or standards, such as Third Generation Partnership Project Long-Term Evolution (3GPP LTE). Fifth Generation New Radio (5G NR), and future evolutions. Multiple wireless links 130 may be aggregated in a carrier aggregation or multi-connectivity technology to provide a higher data rate for the user equipment 110. Multiple wireless links 130 from multiple base stations 120 may be configured for Coordinated Multipoint (COMP) communication with the user equipment 110. Additionally, multiple wireless links 130 may be configured for single-radio access technology (RAT) (single-RAT), dual connectivity (single-RAT-DC), or multi-RAT dual connectivity (MR-DC). The wireless links 130 may be affected by permanent or temporary channel impairments such as buildings, foliage, precipitation, and other moving or stationary objects 180, illustrated as objects 181, 182, and 183.

The base stations 120 are collectively a Radio Access Network 140 (e.g., RAN. Evolved Universal Terrestrial Radio Access Network. E-UTRAN, 5G NR RAN or NR RAN). The base stations 121 and 122 in the RAN 140 are connected to a core network 150. The base stations 121 and 122 connect, at interface 102 and interface 104 respectively, to the core network 150 through an NG2 interface for control-plane signaling and using an NG3 interface for user-plane data communications when connecting to a 5G core network, or using an SI interface for control-plane signaling and user-plane data communications when connecting to an Evolved Packet Core (EPC) network. The base stations 121 and 122 can communicate using an Xn Application Protocol (XnAP) through an Xn interface, or using an X2 Application Protocol (X2AP) through an X2 interface, at interface 106, to exchange user-plane and control-plane data.

The user equipment 110 may connect, via the core network 150, to public networks, such as the Internet 160 to interact with a remote service 170. The remote service 170 represents the computing, communication, and storage devices used to provide any of a multitude of services including interactive voice or video communication, file transfer, streaming voice or video, and other technical services implemented in any manner such as voice calls, video calls, website access, messaging services (e.g., text messaging or multi-media messaging), photo file transfer, enterprise software applications, social media applications, video gaming, streaming video services, and podcasts.

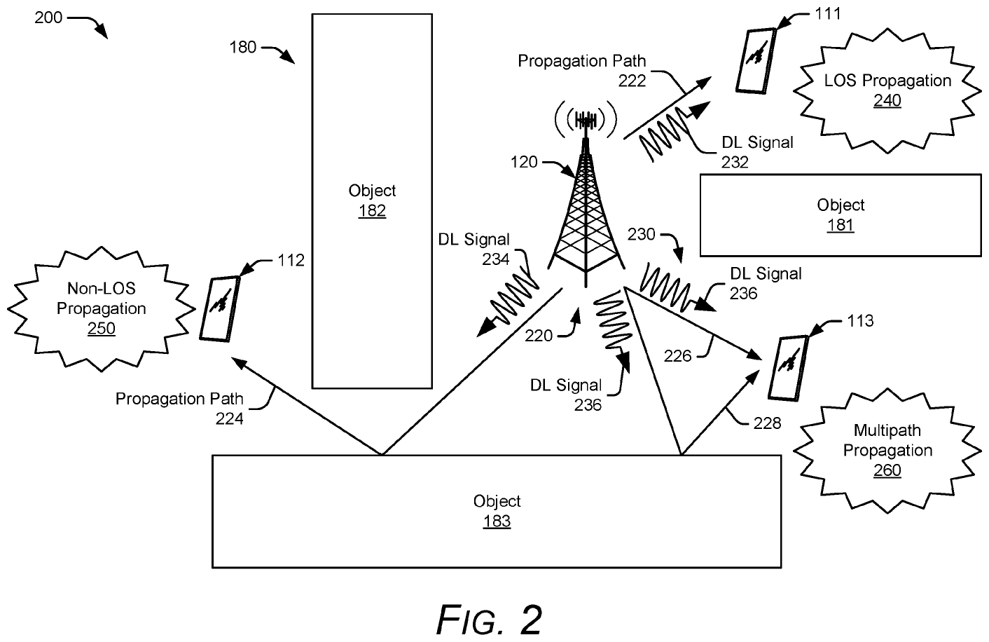

FIG. 2 illustrates an example environment 200 that includes multiple objects 180 between the base station 120 and the UEs 111, 112, and 113. The multiple objects 180 are illustrated as objects 181, 182, and 183. The objects 180 can be stationary or moving. Example stationary objects include buildings, tunnels, bridges, rocks, plants, walls of a room, panes of glass, and furniture. Example moving objects include humans, animals, water vapor, precipitation, and vehicles.

Sometimes the existence and position of the objects 180 within the environment 200 can make it challenging for the base station 120 and the user equipment 111, 112, and 113 to communicate. For example, the objects 180 can cause a wireless communication signal to reflect, diffract, or scatter, which results in the wireless communication signal propagating across multiple propagation paths 220. Sample multiple propagation paths 220 of an omnidirectional signal from the base station 120 include propagation paths 222, 224, 226, and 228. The multiple propagation paths 220 can cause multiple delayed versions of the wireless communication signal to reach a receiving entity at different times. This can cause the received wireless communication signal to become distorted (e.g., due to intersymbol interference (ISI)) or have a smaller signal-to-noise ratio. As another example, an object 180 prevents the base station 120 and the user equipment 110 from having direct line-of-sight communication. As shown in FIG. 2, for instance, the object 182 obstructs the line-of-sight communication between the user equipment 112 and the base station 120.

The techniques for cooperative bistatic radar sensing using deep neural networks enable the base station 120 and the user equipment 111, 112, and 113 to directly measure information about the objects 180 within the current environment 200. This information can include position information (e.g., distance and/or angles), movement information (e.g., Doppler velocity and/or total velocity), size information (e.g., width, length, and/or height), material composition information (e.g., reflection coefficient and/or radar cross section), or some combination thereof. With this information, the base station 120 can determine the propagation environment (e.g., estimate the propagation paths 220) and customize operations to improve wireless communication performance.

For example, the base station 120 tailors its beamforming configurations based on the determined propagation environment to facilitate communications with the user equipment 111, 112, and 113. Additionally or alternatively, the base station 120 directs the user equipment 111, 112, and 113 to utilize particular beamforming configurations. The base station 120 can also direct the user equipment 111, 112, and 113 to utilize customized schedules for transmission and reception (e.g., for beam management). These beamforming configurations can be designed to increase a signal-to-noise ratio at a receiving entity and/or reduce interference. Based on the measured movement of the objects 180, the base station 120 can predict changes in the environment 200 and dynamically adjust the beamforming configurations. In this way, the base station 120 proactively plans wireless communications based on knowledge of the environment 200 obtained using cooperative bistatic radar sensing. Also, the base station 120 can use its knowledge of the propagation environment to cancel received interference from other known propagation paths. This can further improve the signal-to-noise ratio at the base station 120.

Consider an example in which the base station 120 customizes transmission of downlink signals 230 (DL signals 230), illustrated as downlink signals 232, 234, and 236, based on knowledge of the environment 200. To transmit the downlink signal 232 to the user equipment 111, the base station 120 takes advantage of line-of-sight propagation 240. In this case, the base station 120 uses a beamforming configuration to cause the downlink signal 232 to traverse propagation path 222, which is a direct line-of-sight path between the base station 120 and the user equipment 111. An example beamforming configuration produces a radiation pattern with a main lobe that has a narrow beamwidth and is steered along an angle associated with the propagation path 222. By using a narrow beamwidth and steering the main lobe towards the user equipment 111, the base station 120 can reduce losses associated with propagation, reflection, and multipath fading. In this way, the base station 120 can improve wireless communication performance.

To transmit the downlink signal 234 to the user equipment 112, the base station 120 uses non-line-of-sight (non-LOS) propagation 250. In particular, the base station 120 uses another beamforming configuration to cause the downlink signal 234 to traverse a propagation path 224 and reflect off the object 183 towards the user equipment 112. In this way, the downlink signal 234 travels around the object 182. By using the propagation path 224, the base station 120 can overcome the challenges associated with the object 182 obstructing the line-of-sight communication between the base station 120 and the user equipment 112.

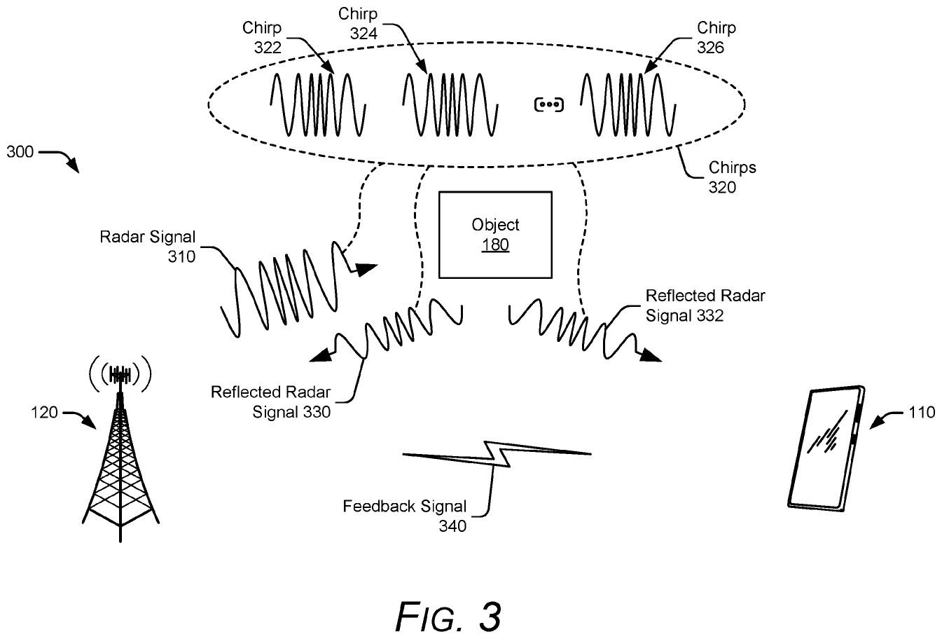

To transmit the downlink signal 236 to the user equipment 113, the base station 120 uses multipath propagation 260. In this case, the downlink signal 236 travels along propagation paths 226 and 228. The propagation path 226 is a direct path along a line-of-sight between the base station 120 and the user equipment 113. In contrast, the propagation path 228 is an indirect path, which causes the downlink signal 236 to reflect off of the object 183 towards the user equipment 113. The base station 120 can utilize the multipath propagation 260 to improve a signal-to-noise ratio at the user equipment 113 and/or increase channel capacity with MIMO techniques. In general, the base station 120 performs channel planning using direct knowledge about the objects 180, which is obtained from cooperative bistatic radar sensing. Operations of the base station 120 and the user equipment 110 for cooperative bistatic radar sensing using deep neural networks are further described with respect to FIG. 3.

FIG. 3 illustrates example signals for cooperative bistatic radar sensing using deep neural networks. In an example environment 300, the base station 120 and the user equipment 110 jointly operate as a bistatic radar to detect the object 180. For example, the base station 120 operates as a transmitter of the bistatic radar, and the user equipment 110 operates as a receiver of the bistatic radar. In some aspects, the user equipment 110 operates as a transmitter of a second bistatic radar, and the base station 120 operates as a receiver of the second bistatic radar. The base station 120 can additionally or alternatively operate as a monostatic radar. In this situation, the base station 120 operates as both a transmitter and a receiver of the monostatic radar. In this example, the base station 120 and the user equipment 110 implement a frequency-modulated continuous-wave radar. However, other types of radars are also possible, including a pulse-Doppler radar, a phase-modulated spread-spectrum radar, an impulse radar, a radar that uses Zadoff-Chu sequences or constant-amplitude zero-autocorrelation (CAZAC) sequences, or a MIMO radar.

During radar sensing, the base station 120 transmits a radar signal 310. The radar signal 310 in this example represents a frequency-modulated signal. In other implementations, the radar signal 310 can include a pulsed signal or a phase-modulated signal. The example radar signal 310 includes a sequence of chirps 320, illustrated as chirps 322, 324, and 326. The chirps 320 can be transmitted in a continuous burst or separated in time. The multiple chirps 320 enable the base station 120 and/or the user equipment 110 to make multiple observations of the object 180 over a predetermined time period.

Frequencies of the chirps 320 can increase or decrease over time. In the depicted example, the base station 120 employs a two-slope cycle (e.g., triangular frequency modulation) to linearly increase and linearly decrease the frequency of each chirp 320 over time. The two-slope cycle enables the base station 120 and the user equipment 110 to measure the Doppler frequency shift caused by motion of the object 180. In general, the base station 120 tailors transmission characteristics of the chirps 320 (e.g., bandwidth, center frequency, duration, and transmit power) to achieve a particular detection range, range resolution, or doppler sensitivity for detecting the object 180.

The radar signal 310 propagates through space and reflects off the object 180. The reflected portions of the radar signal 310 are represented by reflected radar signals 330 and 332. The reflected radar signal 330 propagates back towards the base station 120. The reflected radar signal 332 propagates towards the user equipment 110. Similar to the radar signal 310, the reflected radar signals 330 and 332 are also composed of the chirps 320. As depicted, amplitudes of the reflected radar signals 330 and 332 are smaller than an amplitude of the radar signal 310 due to losses incurred during propagation and reflection.

For cooperative bistatic radar sensing, the user equipment 110 receives the reflected radar signal 332 and process the reflected radar signal 332 to detect the object 180. At the user equipment 110, the reflected radar signal 332 represents a delayed, attenuated version of the radar signal 310. The amount of delay is proportional to a summation of a distance (e.g., slant range) between the base station 120 and the object 180 and a distance between the object 180 and the user equipment 110. In particular, this delay represents a summation of a time it takes for the radar signal 310 to propagate from the base station 120 to the object 180 and a time it takes for the reflected radar signal 332 to propagate from the object 180 to the user equipment 110. If the object 180, the base station 120, or the user equipment 110 is moving, the reflected radar signal 332 is shifted in frequency relative to the radar signal 310 due to the Doppler effect. In other words, certain characteristics of the reflected radar signal 332 are dependent upon the motion of the object 180, the motion of the base station 120, and the motion of the user equipment 110.

The user equipment 110 analyzes the reflected radar signal 332 to extract radar data, which contains implicit or explicit information about the object 180. As an example, the radar data includes raw digital samples of the reflected radar signal 332 or processed information about the reflected radar signal 332 (e.g., amplitude and/or phase information, complex range-Doppler maps, or complex interferometry data). The amplitudes, phases, and frequencies within this example radar data are dependent upon the presence and characteristics of the object 180. As such, the example radar data includes implicit information about the object 180.

The user equipment 110 (or the base station 120) can further process the implicit information associated with the object 180 to determine explicit information about the object 180. The explicit information includes position information, movement information, size information, or material or surface composition information (e.g., human tissue, wood, or metal) of the object 180. In another example, the radar data additionally or alternatively includes the explicit information about the object 180.

To enable the user equipment 110 to determine explicit information about the object 180, the base station 120 can communicate additional information to the user equipment 110. For example, through control signaling that is separate from the radar signal, the base station 120 communicates its position (e.g., a GNSS position) and velocity, waveform characteristics of the radar signal 310, and/or timing of the radar signal 310 for synchronization. In some situations, the user equipment 110 also receives the radar signal 310 through a direct line-of-sight propagation path. As such, the user equipment 110 can directly compare the reflected radar signal 332 to the received radar signal 310 to determine the implicit and explicit information about the object 180. In other situations, the user equipment can replicate the radar signal 310 based on the waveform characteristics and timing information provided by the base station 120. In this way, the user equipment 110 compares the reflected radar signal 332 to the replicated radar signal 310 to determine the implicit and explicit information about the object 180.

The user equipment 110 transmits a feedback signal 340 to communicate the radar data to the base station 120. In some implementations, the user equipment 110 augments the feedback signal 340 to include a position of the user equipment 110 (e.g., a Global Navigation Satellite System (GNSS) position), a velocity of the user equipment 110, an orientation of the user equipment 110, or an antenna configuration of the user equipment 110. The feedback signal 340 propagates through space towards the base station 120 and can use cellular logical channels, such as a Dedicated Control Channel (DCCH), to provide this feedback information.

In some implementations, the base station 120 operates as a full-duplex system to concurrently transmit the radar signal 310 and receive the reflected radar signal 330. In this way, the base station 120 can operate as a continuous-wave monostatic radar. In other implementations, the base station 120 operates as a half-duplex system to transmit the radar signal 310 and receive the reflected radar signal 330. In this way, the base station 120 can operate as a pulse-Doppler monostatic radar. The base station 120 and the user equipment 110 can use time-division duplexing or frequency-division duplexing to enable the base station 120 to transmit the radar signal 310 and receive the feedback signal 340.

For cooperative bistatic radar sensing, the base station 120 processes the feedback signal 340 to determine explicit information about the object 180. In some situations, the base station 120 extracts the explicit information about the object 180 as provided by the user equipment 110 through the feedback signal 340. The base station 120 often receives multiple feedback signals from multiple user equipment 110 and combines the feedback to help determine explicit information about the object 180 as further described below. In some situations, the base station 120 further process the implicit information about the object 180 information as provided by the user equipment 110 through the feedback signal 340 to determine the explicit information.

In another implementation not explicitly shown in FIG. 3, the base station 120 and the user equipment 110 implement a second bistatic radar with the user equipment 110 transmitting the second bistatic radar signal and the base station 120 receiving the second bistatic radar signal. For this second bistatic radar system, the user equipment 110 transmits a second radar signal (in a manner similar to radar signal 310) and the base station 120 receives a version of the second radar signal that is reflected by the object 180. This second radar signal can be a cellular reference signal, such as a sounding reference signal (SRS). In this way, the user equipment 110 operates as a transmitter of the second bistatic radar and the base station 120 operates as a receiver of the second bistatic radar.

For monostatic radar sensing, the base station 120 processes the reflected radar signal 330 to detect the object 180. At the base station 120, the reflected radar signal 330 represents a delayed, attenuated version of the radar signal 310. The amount of delay is proportional to a distance between the base station 120 and the object 180. In particular, this delay represents a summation of a time it takes for the radar signal 310 to propagate from the base station 120 to the object 180 and a time it takes for the reflected radar signal 330 to propagate from the object 180 to the base station 120. If the object 180 or the base station 120 is moving, the reflected radar signal 330 is shifted in frequency relative to the radar signal 310 due to the Doppler effect. In other words, certain characteristics of the reflected radar signal 330 are dependent upon motion of the object 180 and motion of the base station 120. The base station 120 analyzes the reflected radar signal 330 to detect the object 180 and determine information about the object 180 (e.g., position, movement, size, and/or material composition).

In some aspects, the base station 120 combines information about the object 180 as determined using various radar sensing techniques. For example, the base station 120 can combine information determined using a first bistatic radar sensing technique in which the base station 120 operates as a transmitter of a first bistatic radar with (i) information determined using a second bistatic radar sensing technique in which the base station 120 operates as a receiver of a second bistatic radar; and/or (ii) information determined using a monostatic radar sensing technique in which the base station 120 operates as a monostatic radar.

By compiling information about the object 180 through bistatic radar sensing and optionally monostatic radar sensing, the base station 120 can obtain knowledge about a current operating environment, such as the environment 200 shown in FIG. 2. With this knowledge, the base station 120 can map the environment, determine available propagation paths 220, and customize operations for wireless communication accordingly. In general, the cooperative aspect of the cooperative bistatic radar sensing involves the base station 120 and the user equipment 110 communicating with each other to enable explicit information about the object 180 to be determined.

The general concept of cooperative bistatic radar sensing can also be applied to multiple user equipment 110 (e.g., user equipment 111, 112, and 113). In some situations, the base station 120 jointly operates with the multiple user equipment 110 to implement multiple bistatic radars. In other situations, the base station 120 jointly operates with multiple user equipment 110 to implement a multistatic radar. By employing multiple bistatic radars or a multistatic radar, the base station 120 can use triangulation techniques to determine an angular position of the object 180. This can be advantageous in situations in which the user equipment 110 receive the reflected radar signal 332 using a single antenna. In both situations, the base station 120 can combine the information provided by the multiple user equipment 110 to obtain a more accurate estimate of the environment.

### Example Devices

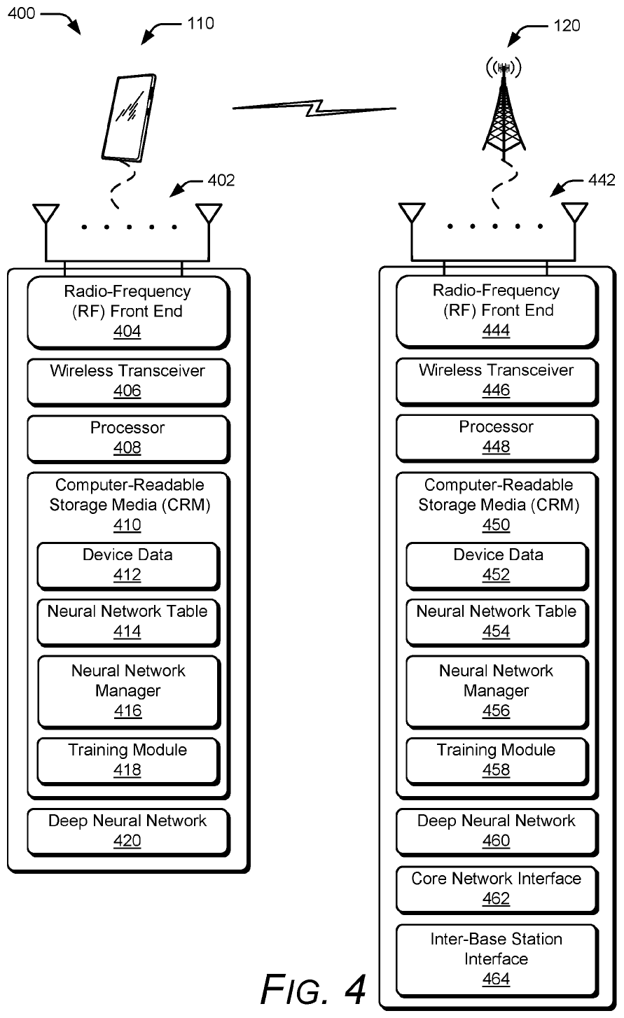

FIG. 4 illustrates an example device diagram 400 of the user equipment 110 and the base station 120 that can implement various aspects of cooperative bistatic radar sensing. The user equipment 110 and the base station 120 can include additional functions and interfaces that are omitted from FIG. 4 for the sake of clarity.

The user equipment 110 includes antennas 402, a radio-frequency front end 404 (RF front end 404), and a wireless transceiver 406 (e.g., an LTE transceiver and/or a 5G NR transceiver). The antennas 402, the radio-frequency front end 404, and the wireless transceiver 406 can be used for communicating with the base station 120 in the RAN 140 and cooperative bistatic radar sensing. The radio-frequency front end 404 couples or connects the wireless transceiver 406 to the antennas 402. The antennas 402 can include an array of multiple antennas that are configured similar to or differently from each other. The antennas 402 and the radio-frequency front end 404 can be tuned to, and/or be tunable to, one or more frequency bands defined by the 3GPP LTE and 5G NR communication standards and implemented by the wireless transceiver 406. By way of example and not limitation, the antennas 402 and the radio-frequency front end 404 can be implemented for operation in sub-GHz bands, sub-6 GHZ bands, and/or above 6 GHZ bands (e.g., GHz bands associated with millimeter wavelengths or terahertz. (THz) bands associated with sub-millimeter wavelengths). Additionally, the antennas 402, the radio-frequency front end 404, and the wireless transceiver 406 may be configured to support beamforming for wireless communication and/or cooperative bistatic radar sensing.

The user equipment 110 also includes at least one processor 408 and at least one computer-readable storage media 410 (CRM 410). The processor 408 may be a single core processor or a multiple core processor composed of a variety of materials, such as silicon, polysilicon, high-K dielectric, copper, and so on. The CRM 410 described herein excludes propagating signals and can include any suitable memory or storage device such as random-access memory (RAM), static RAM (SRAM), dynamic RAM (DRAM), non-volatile RAM (NVRAM), read-only memory (ROM), or Flash memory useable to store device data 412 of the user equipment 110. The device data 412 includes user data, multimedia data, beamforming codebooks, applications, neural network (NN) tables, neural network training data, and/or an operating system of the user equipment 110, some of which are executable by processor(s) 408 to enable user-plane data, control-plane information, and user interaction with the user equipment 110.

In aspects, the CRM 410 includes a neural network table 414, a neural network manager 416, and a training module 418. Alternatively. or additionally, the neural network manager 416 and/or the training module 418 may be implemented in whole or part as hardware logic or circuitry integrated with or separate from other components of the user equipment 110.

The neural network table 414 stores various architecture and/or parameter configurations that form a deep neural network (DNN) 420, such as, by way of example and not of limitation, parameters that specify a fully-connected layer neural network architecture, a convolutional layer neural network architecture, a recurrent neural network layer, a number of connected hidden neural network layers, an input layer architecture, an output layer architecture, a number of nodes utilized by the deep neural network 420, coefficients (e.g., weights and biases) utilized by the deep neural network 420, kernel parameters, a number of filters utilized by the deep neural network 420, strides/pooling configurations utilized by the deep neural network 420, an activation function of each neural network layer, interconnections between neural network layers, neural network layers to skip, and so forth. Accordingly, the neural network table 414 includes any combination of neural network formation configuration elements (NN formation configuration elements). A combination of one or more NN formation configuration elements, such as architecture and/or parameter configurations, can be used to create a neural network formation configuration (NN formation configuration). The NN formation configuration defines and/or forms the deep neural network 420.

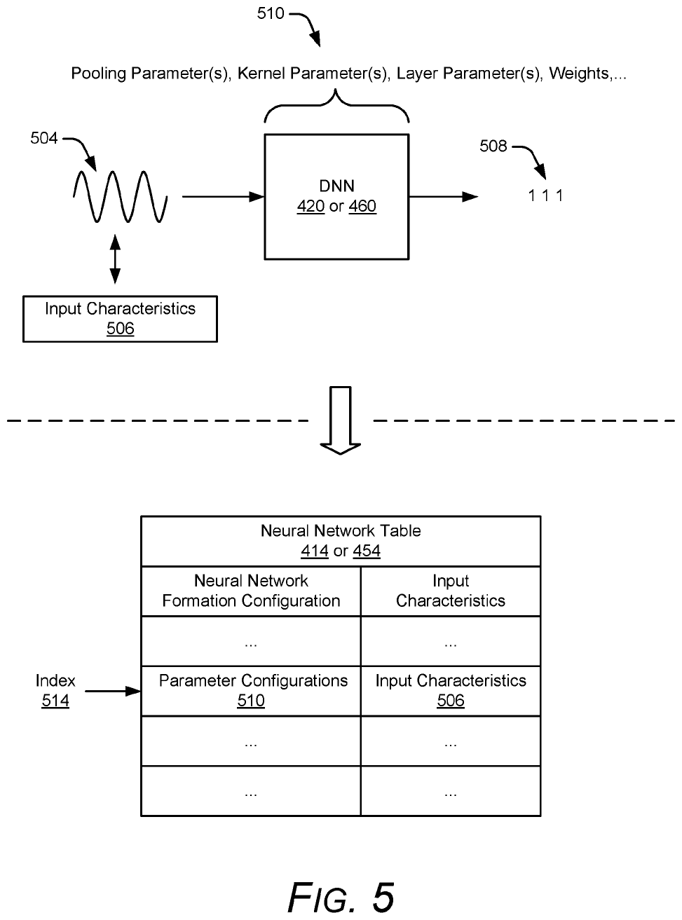

In some aspects, a single index value of the neural network table 414 maps to a single NN formation configuration element (e.g., a 1:1 correspondence). Alternatively. or additionally, a single index value of the neural network table 414 maps to an NN formation configuration (e.g., a combination of NN formation configuration elements). In some implementations, the neural network table 414 includes input characteristics for each NN formation configuration element and/or NN formation configuration, where the input characteristics describe properties about the training data used to generate the NN formation configuration element and/or NN formation configuration as further described with respect to FIG. 5.

The neural network manager 416 accesses the neural network table 414, such as by way of an index value, and forms the deep neural network 420 using the NN formation configuration elements specified by an NN formation configuration. This includes updating the deep neural network 420 with any combination of architectural changes and/or parameter changes. Example changes include a small change that involves updating parameters and/or a large change that reconfigures node and/or layer connections of the deep neural network 420.

In response to receiving an indication from the neural network manager 416, the training module 418 supplies the deep neural network 420 with known input data, such as input data stored as the device data 412. The training module 418 teaches and trains the deep neural network 420 using known input data and/or by providing feedback to the ML algorithm. For instance, the training module 418 trains the deep neural network 420 for cooperative bistatic radar sensing (e.g., processing the reflected radar signal 332 and generating the feedback signal 340). The training module 418 can also train the deep neural network 420 for wireless communication (e.g., encoding uplink communications, modulating uplink communications, demodulating downlink communications, or decoding downlink communications). This wireless communication can use any type of radio access technology (RAT) such as 4G LTE, 5G NR, and future evolutions.

In implementations, the training module 418 extracts updated ML information from the deep neural network 420 and forwards the updated ML information to the neural network manager 416. The extracted updated ML information can include any combination of information that defines the behavior of the deep neural network 420, such as node connections, coefficients, active layers, weights, biases, pooling, etc.

The device diagram for the base station 120, shown in FIG. 4, includes a single network node (e.g., a gNode B). The functionality of the base station 120 may be distributed across multiple network nodes or devices and may be distributed in any fashion suitable to perform the functions described herein. The base station 120 includes antennas 442, at least one radio-frequency front end 444 (RF front end 444), and one or more wireless transceivers 446 (e.g. one or more LTE transceivers and/or one or more 5G NR transceivers). The antennas 442, the radio-frequency front end 444, and the wireless transceiver 446 can be used for communicating with the user equipment 110 and cooperative bistatic radar sensing. In some implementations, the antennas 442, the radio-frequency front end 444, and the wireless transceiver 446 can also be used for monostatic radar sensing. The radio-frequency front end 444 couples or connects the wireless transceiver 446 to the antennas 442. The antennas 442 can include an array of multiple antennas that are configured similar to, or different from, each other. The antennas 442 and the radio-frequency front end 444 can be tuned to, and/or be tunable to, one or more frequency bands defined by the 3GPP LTE and 5G NR communication standards, and implemented by the wireless transceiver 446. By way of example and not limitation, the antennas 442 and the radio-frequency front end 444 can be implemented for operation in sub-GHz bands, sub-6 GHZ bands, and/or above 6 GHz bands (e.g., GHz bands associated with millimeter wavelengths or terahertz. (THz) bands associated with sub-millimeter wavelengths). Additionally, the antennas 442, the radio-frequency front end 444, and/or the wireless transceiver 446 can be configured to support beamforming, such as Massive-MIMO, for wireless communication and radar sensing.

The base station 120 also includes at least one processor 448 and at least one computer-readable storage media 450 (CRM 450). The processor 448 may be a single core processor or a multiple core processor composed of a variety of materials, such as silicon, polysilicon, high-K dielectric, copper, and so on. CRM 450 may include any suitable memory or storage device such as random-access memory (RAM), static RAM (SRAM), dynamic RAM (DRAM), non-volatile RAM (NVRAM), read-only memory (ROM), or Flash memory useable to store device data 452 of the base station 120. The device data 452 includes network scheduling data, radio resource management data, beamforming codebooks, applications, and/or an operating system of the base station 120, which are executable by processor 448 to enable cooperative bistatic radar sensing or wireless communication with the user equipment 110.

The CRM 450 includes a neural network table 454, a neural network manager 456, and a training module 458. Alternatively. or additionally, the neural network manager 456 and/or the training module 458 can be implemented in whole or part as hardware logic or circuitry integrated with or separate from other components of the base station 120.

The neural network table 454 stores various architecture and/or parameter configurations that form a deep neural network 460. Similar to the neural network table 414 of the user equipment 110, the neural network table 454 of the base station 120 includes any combination of NN formation configuration elements and/or NN formation configurations generated using the training module 458. In some implementations, a single index value of the neural network table 454 maps to a single NN formation configuration element (e.g., a 1:1 correspondence). Alternatively. or additionally, a single index value of the neural network table 454 maps to an NN formation configuration (e.g., a combination of NN formation configuration elements).

The training module 458 teaches and/or trains the deep neural network 460 using known input data. For instance, the training module 458 trains the deep neural network 460 for cooperative bistatic radar sensing (e.g., generating the radar signal 310, processing the feedback signal 340, processing a reflected version of a second radar signal transmitted by the user equipment 110, processing the reflected radar signal 330, or modeling propagation paths 220). The training module 458 can also train the deep neural network 460 for wireless communication of any particular RAT (e.g., encoding downlink communications, modulating downlink communications, demodulating uplink communications, or decoding uplink communications).

In implementations, the training module 458 extracts learned parameter configurations from the deep neural network 460 to identify the NN formation configuration elements and/or NN formation configuration, and then adds and/or updates the NN formation configuration elements and/or NN formation configuration in the neural network table 454. The extracted parameter configurations include any combination of information that defines the behavior of the deep neural network 460, such as node connections, coefficients, active layers, weights, biases, or pooling.

In some cases, the base station 120 synchronizes the neural network table 414 of the user equipment 110 with the neural network table 454 such that the NN formation configuration elements and/or input characteristics stored in one neural network table is replicated in the second neural network table. Alternatively. or additionally, the base station 120 synchronizes the neural network table 414 with the neural network table 454 such that the NN formation configuration elements and/or input characteristics stored in one neural network table represent complementary functionality in the second neural network table (e.g., NN formation configuration elements for transmitter path processing in the first neural network table. NN formation configuration elements for receiver path processing in the second neural network table).

Supervised joint training of the deep neural networks 420 and 460 can be performed offline (e.g., while the deep neural networks 420 and 460 are not actively engaged in cooperative bistatic radar sensing or wireless communication). The training data for offline training can include simulated data for various operating environments and radar waveforms and ground truth data that defines the expected output when the simulated data is input to the deep neural networks 420 and 460. Additionally or alternatively, the joint training of the deep neural networks 420 and 460 can be performed online (e.g., while the deep neural networks 420 and 460 are actively engaged in cooperative bistatic radar sensing or wireless communication). In this case, the training data can be provided by a user or a sensor. In general, the training data includes explicit information about the object 180 (e.g., position information, movement information, size information, or material composition information). The training modules 418 and 458 can use gradient descent techniques to train the deep neural networks 420 and 460 and reduce errors.

The base station 120 also includes a core network interface 462, which the base station 120 configures to exchange user-plane data, control-plane information, and/or other data/information with core network functions and/or entities. The base station 120 additionally includes an inter-base station interface 464, such as an Xn and/or X2 interface, which the base station 120 configures to exchange user-plane data, control-plane information, and/or other data/information between other base stations, to manage the communication of the base station 120 with the user equipment 110.

The components of the user equipment 110 and the components of the base station 120 can implement a radar signal transmitter, a radar signal receiver, a feedback signal transmitter, a feedback signal receiver, or some combination thereof to support cooperative bistatic radar sensing, as further described with respect to FIGS. 6-1 and 6-2. Additionally or alternatively, the components of the user equipment 110 and the components of the base station 120 can implement a multipurpose signal transmitter, a multipurpose signal receiver, a multipurpose feedback signal transmitter, a multipurpose feedback signal receiver, or some combination thereof, to support concurrent cooperative bistatic radar sensing and wireless communication, as further described with respect to FIGS. 7-1 to 7-2.

FIG. 5 illustrates aspects of generating multiple NN formation configurations to support cooperative bistatic radar sensing and wireless communication. The upper portion of FIG. 5 includes the deep neural network 420 or 460. In implementations, the neural network manager 416 or 456 generates different NN formation configurations, such as NN formation configurations for cooperative bistatic radar sensing based on different locations of the user equipment 110 or base station 120 or different capabilities of the user equipment 110 or base station 120. Alternatively, or additionally, the neural network manager 416 or 456 generates NN formation configurations based on different environments and/or channel conditions.

Training data 504 represents an example input to the deep neural network 420 or 460. For the deep neural network 420, the training data 504 represents the received reflected radar signal 332 from a particular object 180 and/or a particular propagation environment. For the deep neural network 460, the training data 504 represents radar waveform properties for generating the radar signal 310. In some implementations, the training module 418 or 458 generates the training data 504 mathematically, using a simulation, or accesses a file that stores the training data 504. Other times, the training module 418 or 458 obtains real-world radar data. Thus, the training module 418 or 458 can train the deep neural networks 420 and 460 using mathematically generated data, static data, and/or real-world data. Some implementations generate input characteristics 506 that describe various qualities of the training data 504, such as an operating configuration, transmission channel metrics, base station 120 and/or user equipment 110 capabilities, base station 120 and/or user equipment velocity, base station 120 and/or user equipment 110 positions, or some combination thereof.

The deep neural network 420 or 460 analyzes the training data 504 and generates an output 508 represented here as binary data. Some implementations iteratively train the deep neural network 420 or 460 using the same set of training data 504 and/or additional training data that has the same input characteristics to improve the accuracy of the machine-learning module. During training, the neural network manager 416 or 456 modifies some or all of the architecture and/or parameter configurations of the deep neural network 420 or 460, such as node connections, coefficients, or kernel sizes. At some point in the training, the training module 418 or 458 determines to extract the architecture and/or parameter configurations 510 of the deep neural network 420 or 460 (e.g., pooling parameter(s), kernel parameter(s), layer parameter(s), or weights). This can occur if the training module 418 or 458 determines that the accuracy meets or exceeds a desired threshold (that is, the output 508 from the deep neural network 420 or 460 is seen to converge sufficiently towards the (known) ground truth for the set of training data 504) or the training process meets or exceeds an iteration number. The training module 418 or 458 then extracts the architecture and/or parameter configurations to use as an NN formation configuration and/or NN formation configuration element(s). The architecture and/or parameter configurations can include any combination of fixed architecture and/or parameter configurations, and/or variable architectures and/or parameter configurations.

The lower portion of FIG. 5 includes the neural network table 414 or 454, which represents a collection of NN formation configuration elements. The neural network table 414 or 454 stores various combinations of architecture configurations, parameter configurations, and input characteristics, but alternative implementations omit the input characteristics from the table. Various implementations update and/or maintain the NN formation configuration elements and/or the input characteristics as the deep neural network 420 or 460 learns additional information. For example, at index 514, the neural network manager 416 or 456 and/or the training module 418 or 458 updates the neural network table 414 or 454 to include architecture and/or parameter configurations 510 generated by the deep neural network 420 or 460 while analyzing the training data 504. At a later point in time, the neural network manager 416 or 456 selects one or more NN formation configurations from the neural network table 414 or 454 by matching the input characteristics to a current operating environment and/or configuration.

The neural network manager 416 of the user equipment 110 and the neural network manager 456 of the base station 120 select the NN formation configurations utilized by the deep neural networks 420 and 460 for cooperative bistatic radar sensing. In some implementations, the neural network manager 456 receives NN formation configuration directions from the core network 150 through the core network interface 462 or the inter-base station interface 464 and forwards the NN formation configuration directions to the user equipment 110.

In some implementations, the neural network manager 416 forms multiple deep neural networks 420 for cooperative bistatic radar sensing. As an example, the deep neural network 420 includes a first deep neural network that uses a first NN formation configuration for processing the reflected radar signal 332 and a second deep neural network that uses a second NN formation configuration for generating the feedback signal 340. In some cases, the first NN formation configuration and the second NN formation configuration support concurrent cooperative bistatic radar sensing and wireless communication. For example, the first NN formation configuration enables the first deep neural network to extract downlink signals, such as synchronization signals or reference signals to support wireless communication. Example synchronization signals include primary synchronization signals (PSS) or secondary synchronization signals (SSS) used in cellular communications or preamble training sequences used in wireless local area network (WLAN) communications. Example cellular reference signals include demodulation reference signals (DM-RS), phase-tracking reference signals (PT-RS), channel-state-information reference signals (CSI-RS), or tracking reference signals (TRS). The second NN formation configuration enables the second deep neural network to generate uplink reference signals (e.g., SRS) to support wireless communication.

In other implementations, the neural network manager 416 configures the deep neural network 420 to use a NN formation configuration that both processes the reflected radar signal 332 and generates the feedback signal 340. The deep neural network 420 can also include other deep neural networks that are dedicated to wireless communication.

Additionally or alternatively, the neural network manager 456 forms multiple deep neural networks 460 for cooperative bistatic radar sensing in accordance with an example implementation of the base station 120. For example, the deep neural network 460 includes a first deep neural network that uses a first NN formation configuration for generating the radar signal 310 and a second deep neural network that uses a second NN formation configuration for processing some combination of the reflected radar signal 330, a reflected version of a second radar signal transmitted by the user equipment 110, or the feedback signal 340. In some cases, the first NN formation configuration and the second NN formation configuration support concurrent cooperative bistatic radar sensing and wireless communication.

In another example implementation of the base station, the neural network manager 416 configures the deep neural network 460 to use a NN formation configuration that both generates the radar signal 310 and processes the feedback signal 340. The deep neural network 460 can also include other deep neural networks that are dedicated to wireless communication. For example, the first NN formation configuration enables the first deep neural network to transmit downlink data for wireless communication, and the second NN formation configuration enables the second deep neural network to extract uplink data for wireless communication.

Cooperative Bistatic Radar Sensing using Deep Neural Networks

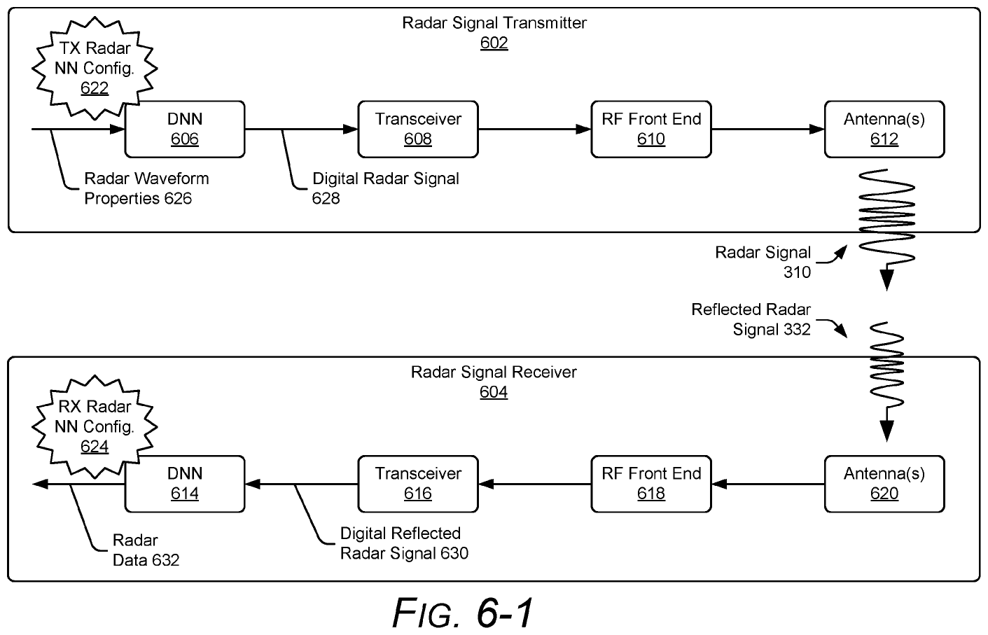

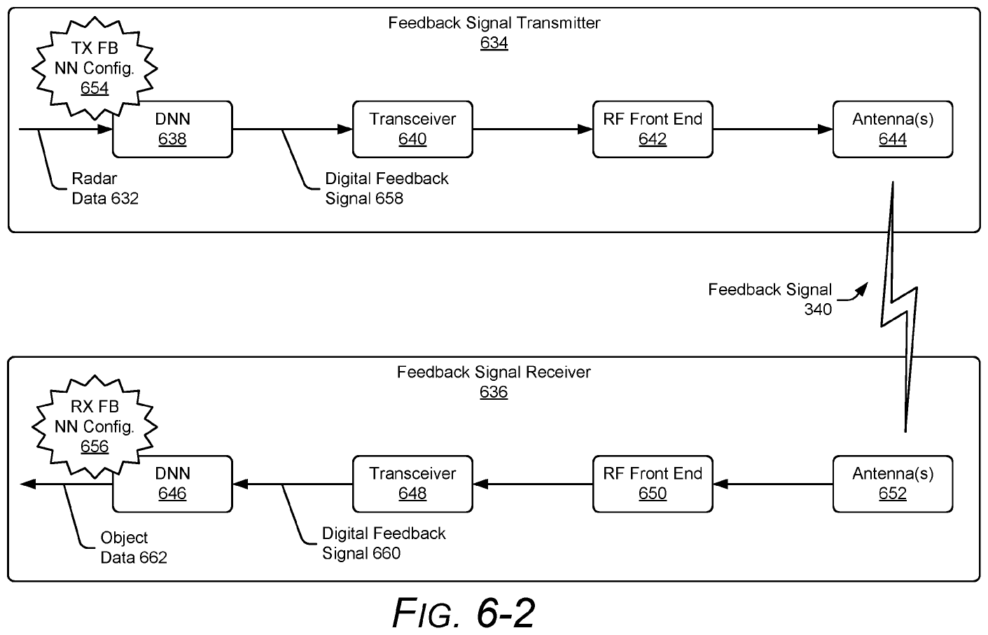

FIG. 6-1 illustrates example operations of a radar signal transmitter 602 and a radar signal receiver 604 for cooperative bistatic radar sensing. The radar signal transmitter 602 and the radar signal receiver 604 are positioned at different locations and together form a bistatic radar. The radar signal transmitter 602 includes a deep neural network 606, a wireless transceiver 608 (transceiver 608), a radio-frequency front end 610, and one or more antennas 612. The radar signal receiver 604 includes a deep neural network 614, a wireless transceiver 616 (transceiver 616), a radio-frequency front end 618, and one or more antennas 620. In FIG. 6-1, the deep neural network 606 of the radar signal transmitter 602 and the deep neural network 614 of the radar signal receiver 604 represent a pair of deep neural networks that enable a radar signal 310 to be transmitted and received for cooperative bistatic radar sensing.

In an example implementation, the base station 120 operates as the radar signal transmitter 602 and the user equipment 110 operates as the radar signal receiver 604 to form a first bistatic radar, as illustrated in FIG. 3. As such, the deep neural network 606 represents the deep neural network 460 of the base station 120, the transceiver 608 represents the transceiver 446 of the base station 120, the radio-frequency front end 610 represents the radio-frequency front end 444 of the base station 120, and the antennas 612 represent the antennas 442 of the base station 120. Also, the deep neural network 614 represents the deep neural network 420 of the user equipment 110, the transceiver 616 represents the transceiver 406 of the user equipment 110, the radio-frequency front end 618 represents the radio-frequency front end 404 of the user equipment 110, and the antennas 620 represent the antennas 402 of the user equipment 110.

In another example implementation, the user equipment 110 operates as the radar signal transmitter 602 and the base station 120 operates as the radar signal receiver 604 to form a second bistatic radar. As such, the deep neural network 606 represents the deep neural network 420 of the user equipment 110, the transceiver 608 represents the transceiver 406 of the user equipment 110, the radio-frequency front end 610 represents the radio-frequency front end 404 of the user equipment 110, and the antennas 612 represent the antennas 402 of the user equipment 110. Also, the deep neural network 614 represents the deep neural network 460 of the base station 120, the transceiver 616 represents the transceiver 446 of the base station 120, the radio-frequency front end 618 represents the radio-frequency front end 444 of the base station 120, and the antennas 620 represent the antennas 442 of the base station 120.

The radar signal transmitter 602 uses the deep neural network 606, the transceiver 608, the radio-frequency front end 610, and one or more of the antennas 612 to transmit the radar signal 310. A neural network manager (e.g., the neural network manager 456 or 416) configures the deep neural network 606 according to a transmit (TX) radar neural network (NN) formation configuration 622 (configuration 622), which can be stored by a neural network table (e.g., the neural network table 454 or 414). Using the configuration 622, the deep neural network 606 performs signal generation for cooperative bistatic radar sensing. In general, the deep neural network 606 performs some or all of the functionality of a bistatic radar's transmitter to generate the radar signal 310. For example, the deep neural network 606 can implement a waveform generation stage, a coherence stage, a modulation stage, or a digital beamforming stage, to generate a digital representation of the radar signal 310.

The transceiver 608 is coupled to the deep neural network 606 and performs operations such as digital-to-analog conversion, upconversion, amplification, and/or filtering. The radio-frequency front end 610 is coupled between the transceiver 608 and the antennas 612. The radio-frequency front end 610 performs operations such as amplification, filtering, and/or phase shifting.

The radar signal receiver 604 uses the deep neural network 614, the transceiver 616, the radio-frequency front end 618, and one or more of the antennas 620 to receive the reflected radar signal 332. A neural network manager (e.g., the neural network manager 416 or 456) configures the deep neural network 614 according to a receive (RX) radar neural network (NN) formation configuration 624 (configuration 624), which can be stored by a neural network table (e.g., the neural network table 414 or 454). Using the configuration 624, the deep neural network 614 performs signal processing for cooperative bistatic radar sensing. In general, the deep neural network 614 performs some or all of the functionality of a bistatic radar's receiver to process the radar signal 310. For example, the deep neural network 614 can implement a demodulation stage, a clutter tracker, an interference-mitigation stage, a Fourier Transform stage (e.g., a fast Fourier Transform (FFT) stage), a threshold-detection stage, a range-processing stage, a Doppler-processing stage, or a digital beamforming stage, to analyze the reflected radar signal 332 and determine implicit or explicit information about the object 180

The transceiver 616 is coupled to the deep neural network 614 and performs operations such as analog-to-digital conversion, downconversion, amplification, and/or filtering. The radio-frequency front end 618 is coupled between the transceiver 616 and the antennas 620. The radio-frequency front end 618 performs operations such as amplification, filtering, and/or phase shifting.

During cooperative bistatic radar sensing, the radar signal transmitter 602 transmits the radar signal 310. In particular, the deep neural network 606 accepts radar waveform properties 626 and generates a digital radar signal 628 based on the radar waveform properties 626. The radar waveform properties 626 can specify a center frequency, a bandwidth, a pulse-repetition frequency (PRF), a beamforming configuration, and/or a modulation type of the radar signal 310. In this manner, the radar waveform properties 626 is provided as an input to the deep neural network 606 and the deep neural network 606 outputs digital samples, which are used to generate the radar signal 310.

In some cases, the radar waveform properties 626 can be determined based on a tracking module of the radar signal transmitter 602. The tracking module can be implemented using an alpha-beta tracker, a Kalman filter, a multiple hypothesis tracker, or another deep neural network. The tracking module takes into account previous measurements of an object 180's position and movement to tailor the radar waveform properties 626 for an estimated position and movement of the object 180. In this way, the radar signal transmitter 602 can increase measurement accuracies and increase a probability of detecting the object 180. For example, the radar signal transmitter 602 can tailor the beamforming configuration to direct a main lobe of a radiation pattern along a predicted angle to the object 180 or adjust the pulse-repetition frequency to increase separation within the Doppler domain between the object 180 and surrounding clutter.

The transceiver 608 accepts the digital radar signal 628 and converts the digital radar signal 628 into an analog signal. The transceiver 608 and the radio-frequency front end 610 further condition the analog signal for transmission. For example, the transceiver 608 upconverts the analog signal from baseband frequencies to radio frequencies. The radio-frequency front end 610 amplifies the analog signal, applies phase shifts for analog beamforming, or filters the analog signal to remove spurious frequencies. The antennas 612 transmit the analog signal, which represents the radar signal 310.

The radar signal receiver 604 receives the reflected radar signal 332 using one or more of the antennas 620. The antennas 620 pass the reflected radar signal 332 to the radio-frequency front end 618. The radio-frequency front end 618 and the transceiver 616 can further condition the reflected radar signal 332 for processing. For example, the radio-frequency front end 618 amplifies the reflected radar signal 332, applies phase shifts for analog beamforming, or filters the reflected radar signal 332 to remove interference. The transceiver 616 downconverts the reflected radar signal 332 from radio frequencies to baseband frequencies. The transceiver 616 also performs analog-to-digital conversion to generate a digital representation of the reflected radar signal 332, which is shown as digital reflected radar signal 630.

The deep neural network 614 accepts the digital reflected radar signal 630 and processes the digital reflected radar signal 630 to generate radar data 632. In this manner, digital samples of the digital reflected radar signal 630 are provided as inputs to the deep neural network 614 and the deep neural network 614 outputs the radar data 632, which includes implicit and/or explicit information about the object 180. In some situations, the radar signal receiver 604 provides the radar data 632 to applications running on a device that includes the radar signal receiver 604. As an example, the device can use the radar data 632 to perform gesture recognition, collision avoidance, or health monitoring. In some situations, the radar signal receiver 604 also receives the radar signal 310 and processes the radar signal 310 to enable bistatic radar techniques.

Sometimes a device (e.g., the user equipment 110 or the base station 120) includes both the radar signal transmitter 602 and the radar signal receiver 604. In this case, the device can use the radar signal transmitter 602 and the radar signal receiver 604 for monostatic radar sensing. In particular, the radar signal receiver 604 processes the reflected radar signal 330 to determine explicit information about the object 180.

Although not shown, at least a portion of the components of the radar signal transmitter 602 and/or the radar signal receiver 604 can also be used for wireless communication, such as cellular data signaling or WLAN signaling. In this situation, the radar signal transmitter 602 connects the transceiver 608 to another deep neural network associated with wireless communication (or reconfigures the deep neural network 606 for wireless communication). Likewise, the radar signal receiver 604 can connect the transceiver 608 to another deep neural network associated with wireless communication (or reconfigure the deep neural network 614). Additional operations for cooperative bistatic radar sensing are further described with respect to FIG. 6-2.

FIG. 6-2 illustrates example operations of a feedback signal transmitter 634 and a feedback signal receiver 636 for cooperative bistatic radar sensing. The feedback signal transmitter 634 is co-located with the radar signal receiver 604, and the feedback signal receiver 636 is co-located with the radar signal transmitter 602. The feedback signal transmitter 634 includes a deep neural network 638, a wireless transceiver 640) (transceiver 640), a radio-frequency front end 642, and one or more antennas 644. The feedback signal receiver 636 includes a deep neural network 646, a wireless transceiver 648 (transceiver 648), a radio-frequency front end 650, and one or more antennas 652. In FIG. 6-2, the deep neural network 638 of the feedback signal transmitter 634 and the deep neural network 646 of the feedback signal receiver 636 represent a pair of deep neural networks that enable a feedback signal 340 to be transmitted and received for cooperative bistatic radar sensing.

In some implementations, the feedback signal transmitter 634 uses different components from the radar signal receiver 604. For example, the deep neural network 638 of the feedback signal transmitter 634 is different than (e.g., distinct from) the deep neural network 614 of the radar signal receiver 604. In this case, the deep neural network 638 is designed and trained for feedback signal generation, and the deep neural network 614 is designed and trained for radar signal processing. Likewise, the feedback signal receiver 636 can use different components than the radar signal transmitter 602. In particular, the deep neural network 646 of the feedback signal receiver 636 is different than the deep neural network 606 of the radar signal transmitter 602. In this case, the deep neural network 646 is designed and trained for feedback signal processing, and the deep neural network 606 is designed and trained for radar signal generation.

In other implementations, the feedback signal transmitter 634 uses the same components as the radar signal receiver 604. For example, the deep neural network 638 of the feedback signal transmitter 634 and the deep neural network 614 of the radar signal receiver 604 can be integrated together to form a single deep neural network that services both the feedback signal transmitter 634 and the radar signal receiver 604. The feedback signal transmitter 634 and the radar signal receiver 604 can also share the same transceiver, radio-frequency front end, antennas, or some combination thereof. The feedback signal receiver 636 can also use the same components as the radar signal transmitter 602. For example, the deep neural network 646 of the feedback signal receiver 636 and the deep neural network 606 of the radar signal transmitter 602 can be the same deep neural network that reuses the same NN nodes with different configurations. The feedback signal receiver 636 and the radar signal transmitter 602 can also share the same transceiver, radio-frequency front end, antennas, or some combination thereof.

If the base station 120 and the user equipment 110 form the first bistatic radar described above with respect to FIG. 6-1, the user equipment 110 operates as the feedback signal transmitter 634 and the base station 120 operates as the feedback signal receiver 636. As such, the deep neural network 638 represents the deep neural network 420 of the user equipment 110, the transceiver 640 represents the transceiver 406 of the user equipment 110, the radio-frequency front end 642 represents the radio-frequency front end 404 of the user equipment 110, and the antennas 644 represent the antennas 402 of the user equipment 110. Also, the deep neural network 646 represents the deep neural network 460 of the base station 120, the transceiver 648 represents the transceiver 446 of the base station 120, the radio-frequency front end 650 represents the radio-frequency front end 444 of the base station 120, and the antennas 652 represent the antennas 442 of the base station 120.

If the base station 120 and the user equipment 110 form the second bistatic radar, the base station 120 operates as the feedback signal transmitter 634 and the user equipment 110 operates as the feedback signal receiver 636. As such, the deep neural network 638 represents the deep neural network 460 of the base station 120, the transceiver 640 represents the transceiver 446 of the base station 120, the radio-frequency front end 642 represents the radio-frequency front end 444 of the base station 120, and the antennas 612 represent the antennas 442 of the base station 120. Also, the deep neural network 646 represents the deep neural network 420 of the user equipment 110, the transceiver 648 represents the transceiver 406 of the user equipment 110, the radio-frequency front end 650 represents the radio-frequency front end 404 of the user equipment 110, and the antennas 652 represent the antennas 402 of the user equipment 110.

A neural network manager (e.g., the neural network manager 416 or 456) configures the deep neural network 638 according to a transmit (TX) feedback (FB) neural network (NN) formation configuration 654 (configuration 654), which can be stored by a neural network table (e.g., the neural network table 414 or 454). Using the configuration 654, the deep neural network 638 performs feedback signal generation for cooperative bistatic radar sensing. In general, the deep neural network 638 performs some or all transmitter processing functionality to generate the feedback signal 340. In particular, the deep neural network 638 can implement an encoding stage and a modulation stage to generate a digital representation of the feedback signal 340.

A neural network manager (e.g., the neural network manager 456 or 416) configures the deep neural network 646 according to a receive (RX) feedback neural network (NN) formation configuration 656 (configuration 656), which can be stored by a neural network table (e.g., the neural network table 454 or 414). Using the configuration 656, the deep neural network 646 performs feedback signal processing for cooperative bistatic radar sensing. In general, the deep neural network 646 performs some or all of the functionality of a receiver processing functionality to process the feedback signal 340. In particular, the deep neural network 646 can implement a demodulating stage and a decoding stage to extract the radar data 632 provided by the feedback signal 340.

During cooperative bistatic radar sensing, the feedback signal transmitter 634 transmits the feedback signal 340. In particular, the deep neural network 638 accepts the radar data 632 (of FIG. 6-1), and generates a digital feedback signal 658 based on the radar data 632. In this manner, the radar data 632 is provided as an input to the deep neural network 638 and the deep neural network 638 outputs digital samples, which are used to generate the feedback signal 340.

The transceiver 640 accepts the digital feedback signal 658 and converts the digital feedback signal 658 into an analog signal. The transceiver 640 and the radio-frequency front end 642 further condition the analog signal for transmission. For example, the transceiver 640) upconverts the analog signal from baseband frequencies to radio frequencies. The radio-frequency front end 642 amplifies the analog signal, applies phase shifts for analog beamforming, or filters the analog signal to remove spurious frequencies. The antennas 644 transmit the analog signal, which represents the feedback signal 340.

The feedback signal receiver 636 receives the feedback signal 340 using one or more of the antennas 652. The antennas 652 pass the feedback signal 340 to the radio-frequency front end 650. The radio-frequency front end 650 and the transceiver 648 can further condition the feedback signal 340 for processing. For example, the radio-frequency front end 650 amplifies the feedback signal 340, applies phase shifting for analog beamforming, and/or filters the feedback signal 340 to remove interference. The transceiver 648 downconverts the feedback signal 340 from radio frequencies to baseband frequencies. The transceiver 648 also performs analog-to-digital conversion to generate a digital representation of the feedback signal 340, which is shown as digital feedback signal 660.

The deep neural network 646 accepts the digital feedback signal 660 and processes the digital feedback signal 660 to generate object data 662. In this manner, digital samples of the digital feedback signal 660 are provided as inputs to the deep neural network 646 and the deep neural network 646 outputs the object data 662. Sometimes, the feedback signal receiver 636 compiles object data 662 from radar data 632 transmitted by one or more feedback signal transmitters 634 as well as object data determined using monostatic radar sensing. With the object data 662, the feedback signal receiver 636 can model the environment and estimate the propagation paths 220 to improve wireless communication performance.

The operations for cooperative bistatic radar sensing can run according to a frequency-division duplexing (FDD) system or a time-division duplexing (TDD) system. To implement the FDD system, the radar signal 310 and the feedback signal 340 utilize separate frequency bands. In this way, the radar signal transmitter 602 can concurrently transmit the radar signal 310 and receive the feedback signal 340 and/or the reflected radar signal 330. To implement the TDD system, the radar signal transmitter 602 transmits the radar signal 310 during a specified time slot and the feedback signal receiver 636 transmits the feedback signal 340 during another specified time slot. In this case, the radar signal 310 and the feedback signal 340 can utilize the same frequency band. In some instances, concurrent cooperative bistatic radar sensing and wireless communication can be performed, as further described with respect to FIGS. 7-1 and 7-2.

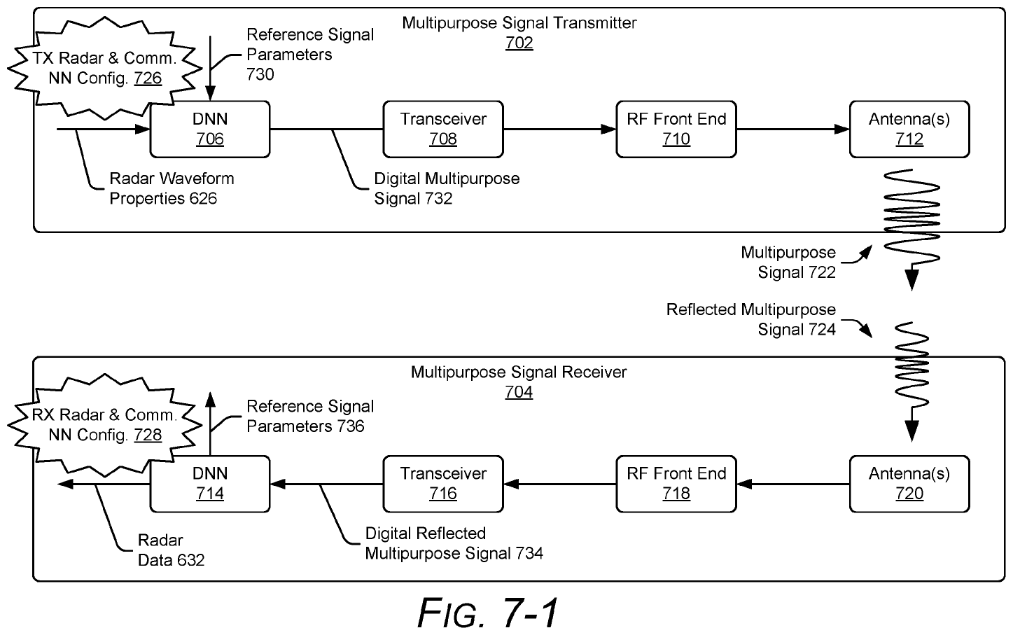

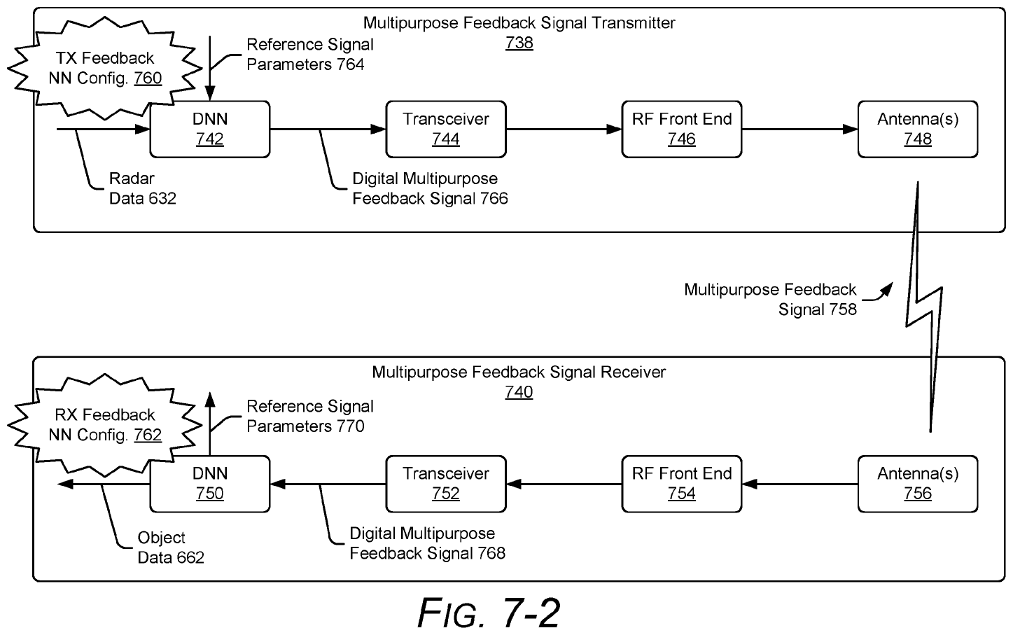

FIG. 7-1 illustrates example operations of a multipurpose signal transmitter 702 and a multipurpose signal receiver 704 for concurrent cooperative bistatic radar sensing and wireless communication. The multipurpose signal transmitter 702 and the multipurpose signal receiver 704 are positioned at different locations and together form a bistatic radar. The multipurpose signal transmitter 702 includes a deep neural network 706, a wireless transceiver 708 (transceiver 708), a radio-frequency front end 710, and one or more antennas 712. The multipurpose signal receiver 704 includes a deep neural network 714, a wireless transceiver 716 (transceiver 716), a radio-frequency front end 718, and one or more antennas 720. In FIG. 7-1, the deep neural network 706 of the multipurpose signal transmitter 702 and the deep neural network 714 of the multipurpose signal receiver 704 represent a pair of deep neural networks that enable a multipurpose signal 722 to be transmitted and a reflected version of the multipurpose signal 722 (e.g., a reflected multipurpose signal 724) to be received for concurrent cooperative bistatic radar sensing and wireless communication.

In an example implementation, the base station 120 operates as the multipurpose signal transmitter 702 and the user equipment 110 operates as the multipurpose signal receiver 704 to form a first bistatic radar, as illustrated in FIG. 3. As such, the deep neural network 706 represents the deep neural network 460 of the base station 120, the transceiver 708 represents the transceiver 446 of the base station 120, the radio-frequency front end 710 represents the radio-frequency front end 444 of the base station 120, and the antennas 712 represent the antennas 442 of the base station 120. Also, the deep neural network 714 represents the deep neural network 420 of the user equipment 110, the transceiver 716 represents the transceiver 406 of the user equipment 110, the radio-frequency front end 718 represents the radio-frequency front end 404 of the user equipment 110, and the antennas 720 represent the antennas 402 of the user equipment 110.

In another example implementation, the user equipment 110 operates as the multipurpose signal transmitter 702 and the base station 120 operates as the multipurpose signal receiver 704 to form a second bistatic radar. As such, the deep neural network 706 represents the deep neural network 420 of the user equipment 110, the transceiver 708 represents the transceiver 406 of the user equipment 110, the radio-frequency front end 710 represents the radio-frequency front end 404 of the user equipment 110, and the antennas 712 represent the antennas 402 of the user equipment 110. Also, the deep neural network 714 represents the deep neural network 460 of the base station 120, the transceiver 716 represents the transceiver 446 of the base station 120, the radio-frequency front end 718 represents the radio-frequency front end 444 of the base station 120, and the antennas 720 represent the antennas 442 of the base station 120.

A neural network manager (e.g., the neural network manager 456 or 416) configures the deep neural network 706 according to a transmit (TX) radar and communication neural network (NN) formation configuration 726 (configuration 726), which can be stored by a neural network table (e.g., the neural network table 454 or 414). Using the configuration 726, the deep neural network 706 performs signal generation for concurrent cooperative bistatic radar sensing and wireless communication. In general, the deep neural network 706 performs some or all of the functionality of the radar signal transmitter 602 to generate the radar signal 310 and transmitter processing functionality to transmit wireless communication data. For example, the deep neural network 706 can implement a waveform generation stage, a coherence stage, a modulation stage, a digital beamforming stage, an encoding stage, or a multiplexing stage.

A neural network manager (e.g., the neural network manager 416 or 456) configures the deep neural network 714 according to a receive (RX) radar and communication neural network (NN) formation configuration 728 (configuration 728), which can be stored by a neural network table (e.g., the neural network table 414 or 454). Using the configuration 728, the deep neural network 714 performs signal processing for cooperative bistatic radar sensing and wireless communication. In general, the deep neural network 714 performs some or all of the functionality of the radar signal receiver 604 to process the radar signal 310 and receiver processing functionality for extracting the wireless communication data. For example, the deep neural network 420 can implement a demodulation stage, a clutter tracker, an interference-mitigation stage, a Fourier Transform stage (e.g., a fast Fourier Transform (FFT) stage), a threshold-detection stage, a range-processing stage, a Doppler-processing stage, a digital beamforming stage, a decoding stage or a demultiplexing stage.

During concurrent cooperative bistatic radar sensing and wireless communication, the multipurpose signal transmitter 702 transmits the multipurpose signal 722, which represents a combination of the radar signal 310 and a wireless communication signal. The wireless communication signal can be a cellular reference signal, such as a stand-alone reference signal, a reference preamble preceding a data signal, and/or a reference signal interleaved with a data signal in time and frequency. In particular, the deep neural network 706 accepts the radar waveform properties 626 and reference signal parameters 730, and generates a digital multipurpose signal 732 based on the radar waveform properties 626 and the reference signal parameters 730. In one aspect, the deep neural network 706 generates the digital radar signal 628 (of FIG. 6-1) and multiplexes the reference signal parameters 730 onto the digital radar signal 628 (e.g., using PHY-layer multiplexing or different radio bearers). In another aspect, the deep neural network 706 modulates a reference signal onto the digital radar signal 628 (or modulates the digital radar signal 628 onto the reference signal). If the reference signal is associated with an uplink reference signal, the reference signal can be a sounding reference signal (SRS). Alternatively, if the reference signal is associated with a downlink reference signal or a synchronization signal, the reference signal can be a demodulation reference signal, a phase-tracking reference signal, a channel-state-information reference signal, a tracking reference signal, a primary synchronization signal, or a secondary synchronization signal. The resulting signal transmitted by the antennas 712 is the multipurpose signal 722, which can be optionally used for cooperative bistatic radar sensing and/or wireless communication.

The multipurpose signal receiver 704 receives a reflected version of the multipurpose signal 722, which is shown as the reflected multipurpose signal 724. The deep neural network 714 accepts a digital reflected multipurpose signal 734, which is a digital representation of the reflected multipurpose signal 734. By processing the digital reflected multipurpose signal 734, the deep neural network 714 reconstructs the reference signal parameters 730 as reference signal parameters 736 and generates the radar data 632.

Sometimes a device (e.g., the user equipment 110 or the base station 120) includes both the multipurpose signal transmitter 702 and the multipurpose signal receiver 704. In this case, the device can use the multipurpose signal transmitter 702 and the multipurpose signal receiver 704 for monostatic radar sensing. In particular, the multipurpose signal receiver 704 processes another reflected version of the multipurpose signal 722 to determine explicit information about the object 180. Additional operations for concurrent cooperative bistatic radar sensing and wireless communication are further described with respect to FIG. 7-2.

FIG. 7-2 illustrates example operations of a multipurpose feedback signal transmitter 738 and a multipurpose feedback signal receiver 740 for concurrent cooperative bistatic radar sensing and wireless communication. The multipurpose feedback signal transmitter 738 is co-located with the multipurpose signal receiver 704, and the multipurpose feedback signal receiver 740 is co-located with the multipurpose signal transmitter 702. The multipurpose feedback signal transmitter 738 includes a deep neural network 742, a wireless transceiver 744 (transceiver 744), a radio-frequency front end 746, and one or more antennas 748. The multipurpose feedback signal receiver 740 includes a deep neural network 750, a wireless transceiver 752 (transceiver 752), a radio-frequency front end 754, and one or more antennas 756. In FIG. 7-2, the deep neural network 742 of the multipurpose feedback signal transmitter 738 and the deep neural network 750 of the multipurpose feedback signal receiver 740 represent a pair of deep neural networks that enable a multipurpose feedback signal 758 to be transmitted and received for concurrent cooperative bistatic radar sensing and wireless communication.

In some implementations, the multipurpose feedback signal transmitter 738 uses different components as the multipurpose signal receiver 704. For example, the deep neural network 742 of the multipurpose feedback signal transmitter 738 is different than the deep neural network 714 of the multipurpose signal receiver 704. In this case, the deep neural network 742 is designed and trained for multipurpose feedback signal generation, and the deep neural network 714 is designed and trained for multipurpose signal processing. Likewise, the multipurpose feedback signal receiver 740 can use different components than the multipurpose signal transmitter 702. In particular, the deep neural network 750 of the multipurpose feedback signal receiver 740 is different than the deep neural network 706 of the multipurpose signal transmitter 702. In this case, the deep neural network 750 is designed and trained for multipurpose feedback signal processing, and the deep neural network 706 is designed and trained for multipurpose signal generation.

In other implementations, the multipurpose feedback signal transmitter 738 uses the same components as the multipurpose signal receiver 704. For example, the deep neural network 742 of the multipurpose feedback signal transmitter 738 and the deep neural network 714 of the multipurpose signal receiver 704 can be integrated together to form a single deep neural network that services both the multipurpose feedback signal transmitter 738 and the multipurpose signal receiver 704. The multipurpose feedback signal transmitter 738 and the multipurpose signal receiver 704 can also share the same transceiver, radio-frequency front end, antennas, or some combination thereof. The multipurpose feedback signal receiver 740 can also use the same components as the multipurpose signal transmitter 702. For example, the deep neural network 750 of the multipurpose feedback signal receiver 740 and the deep neural network 706 of the multipurpose signal transmitter 702 can be the same deep neural network that reuses the same NN nodes with different configurations. The multipurpose feedback signal receiver 740 and the multipurpose signal transmitter 702 can also share the same transceiver, radio-frequency front end, antennas, or some combination thereof.

If the base station 120 and the user equipment 110 form the first bistatic radar described above with respect to FIG. 7-1, the user equipment 110 operates as the multipurpose feedback signal transmitter 738 and the base station 120 operates as the multipurpose feedback signal receiver 740. As such, the deep neural network 742 represents the deep neural network 420 of the user equipment 110, the transceiver 744 represents the transceiver 406 of the user equipment 110, the radio-frequency front end 746 represents the radio-frequency front end 404 of the user equipment 110, and the antennas 748 represent the antennas 402 of the user equipment 110. Also, the deep neural network 750 represents the deep neural network 460 of the base station 120, the transceiver 752 represents the transceiver 446 of the base station 120, the radio-frequency front end 754 represents the radio-frequency front end 444 of the base station 120, and the antennas 756 represent the antennas 442 of the base station 120.

If the base station 120 and the user equipment 110 form the second bistatic radar, the base station 120 operates as the multipurpose feedback signal transmitter 738 and the user equipment 110 operates as the multipurpose feedback signal receiver 740. As such, the deep neural network 742 represents the deep neural network 460 of the base station 120, the transceiver 744 represents the transceiver 446 of the base station 120, the radio-frequency front end 746 represents the radio-frequency front end 444 of the base station 120, and the antennas 748 represent the antennas 442 of the base station 120. Also, the deep neural network 750 represents the deep neural network 420 of the user equipment 110, the transceiver 752 represents the transceiver 406 of the user equipment 110, the radio-frequency front end 754 represents the radio-frequency front end 404 of the user equipment 110, and the antennas 756 represent the antennas 402 of the user equipment 110.

A neural network manager (e.g., the neural network manager 416 or 456) configures the deep neural network 742 according to a transmit (TX) feedback neural network (NN) formation configuration 760 (configuration 760), which can be stored by a neural network table (e.g., the neural network table 414 or 454). Using the configuration 760, the deep neural network 742 performs signal generation for concurrent cooperative bistatic radar sensing and wireless communication. In general, the deep neural network 742 performs some or all transmitter processing functionality to generate the feedback signal 340 and transmit wireless communication data. In particular, the deep neural network 742 can implement an encoding stage, a multiplexing stage, and a modulation stage.

A neural network manager (e.g., the neural network manager 456 or 416) configures the deep neural network 750 according to a receive (RX) feedback neural network (NN) formation configuration 762 (configuration 762), which can be stored by a neural network table (e.g., the neural network table 454 or 414). Using the configuration 762, the deep neural network 750 performs signal processing for concurrent cooperative bistatic radar sensing and wireless communication. In general, the deep neural network 750 performs some or all of the functionality of a receiver processing functionality to process the feedback signal 340 and extract the wireless communication data. In particular, the deep neural network 750 can implement a decoding stage, a demultiplexing stage, and a demodulation stage.

During concurrent cooperative bistatic radar sensing and wireless communication, the multipurpose feedback signal transmitter 738 transmits the multipurpose feedback signal 758, which represents a combination of the feedback signal 340 and a wireless communication signal. The wireless communication signal can be a cellular reference signal as previously described. In particular, the deep neural network 742 accepts the radar data 632 and reference signal parameters 764, and generates a digital multipurpose feedback signal 766 based on the radar data 632 and the reference signal parameters 764. In one aspect, the deep neural network 742 generates the digital feedback signal 658 (of FIG. 6-2) and multiplexes the reference signal parameters 764 onto the digital feedback signal 658 (e.g., using PHY-layer multiplexing or different radio bearers). In another aspect, the deep neural network 742 modulates a reference signal onto the digital feedback signal 658 (or modulates the digital feedback signal 658 onto the reference signal). If the reference signal is associated with an uplink reference signal, the reference signal can be a sounding reference signal. Alternatively, if the reference signal is associated with a downlink reference signal or a synchronization signal, the reference signal can be a demodulation reference signal, a phase-tracking reference signal, a channel-state-information reference signal, a tracking reference signal, a primary synchronization signal, or a secondary synchronization signal. The resulting signal transmitted by the antennas 748 is the multipurpose feedback signal 758, which can be optionally used for cooperative bistatic radar sensing and/or wireless communication.

The multipurpose feedback signal receiver 740 receives the multipurpose feedback signal 758. The deep neural network 750 accepts a digital multipurpose feedback signal 768, which is a digital representation of the multipurpose feedback signal 758. By processing of the digital multipurpose feedback signal 768, the multipurpose feedback signal receiver 740 reconstructs the reference signal parameters 764 as reference signal parameters 770 and generates the object data 662.

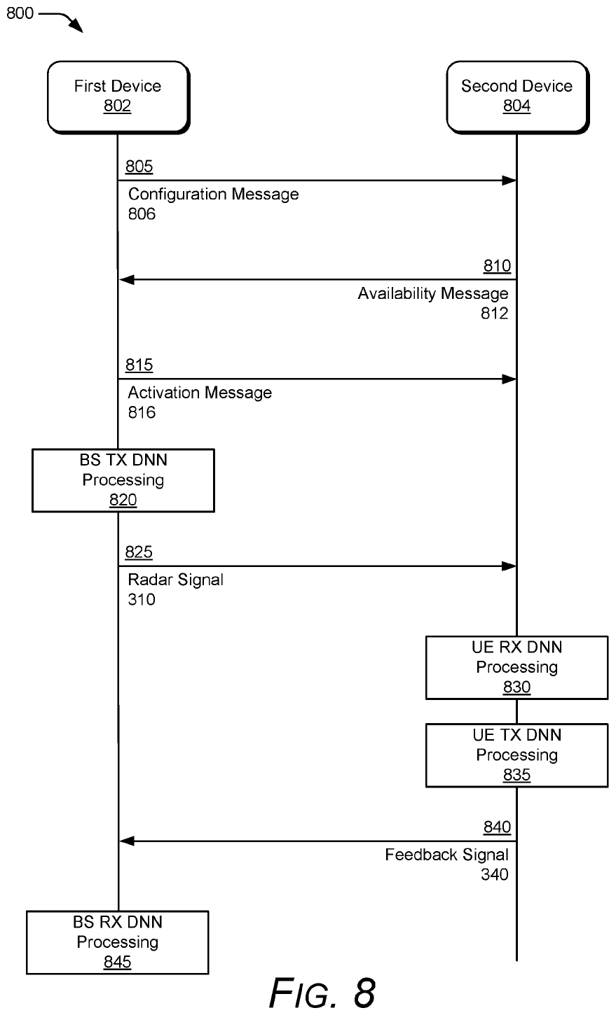

FIG. 8 illustrates an example transaction diagram 800 between a first device 802 and a second device 804 for cooperative bistatic radar sensing. In this case, the first device 802 operates as the radar signal transmitter 602 and the feedback signal receiver 636. The second device 804 operates as the radar signal receiver 604 and the feedback signal transmitter 634. In this example, the first device 802 is the base station 120 and the second device 804 is the user equipment 110. In another example, the first device 802 is the user equipment 110 and the second device 804 is the base station 120. In this case, the second device 815 (e.g., the base station 120) can perform the operations at 805 and 815 instead of the first device 802, and the first device 802 (e.g., the user equipment 110) can perform the operation at 810 instead of the second device 804.

At 805, the first device 802 configures a deep neural network of the second device 804 for cooperative bistatic radar sensing. In particular, the first device 802 transmits a configuration message 806 to the second device 804. The configuration message 806 can include a specific NN formation configuration elements or an index to a neural network table (e.g., indexes to the receive radar NN formation configuration 624 and the transmit feedback NN formation configuration 654).

The configuration message 806 can also include information about the first device 802 or information about an upcoming radar signal 310. For example, the information about the first device 802 can include the position, movement, or antenna configuration of the first device 802. The information about the upcoming radar signal 310 can include the radar waveform properties 626 or timing information. In some aspects, the first device 802 uses a frequency band to communicate the configuration message 806 that differs from a frequency band used for cooperative bistatic radar sensing. As an example, the frequency band can be associated with a side channel.

At 810, the second device 804 communicates its availability to the first device 802. In particular, the second device 804 transmits an availability message 812, which provides information about the ability of the second device 804 to support cooperative bistatic radar sensing. The availability message 812 can include information regarding a battery level of the second device 804, processing capability, antenna configurations, and transmit power levels. The operations at 805 and 810 can occur concurrently or in different sequences.

At 815, the first device 802 activates one or more second devices 804 for cooperative bistatic radar sensing. For example, the first device 802 transmits an activation message 816 to the second device 804, which causes the second device 804 to support cooperative bistatic radar sensing.

In some cases, the first device 802 can select a group of second device 804. The selection can be designed to obtain additional information on a particular object 180 within the environment, based on the relative proximity of the second devices 804 within the group, or based on the position of the second devices 804 along a particular angle. In general, the first device 802 selects multiple second devices 804 that are likely to observe reflections of the radar signal 310 off of a same object 180. The activation message 816 can be implemented as a beam-specific paging message.

At 820, the first device 802 performs radar signal generation using transmit deep-neural-network processing. For example, the deep neural network 606 of the radar signal transmitter 602 uses the transmit radar NN formation configuration 622 to generate the digital radar signal 628 based on the radar waveform properties 626, as described above with respect to FIG. 6-1. Sometimes, the first device 802 supports concurrent cooperative bistatic radar sensing and wireless communication. In this situation, the deep neural network 706 of the multipurpose signal transmitter 702 uses the transmit radar and communication NN formation configuration 726 to generate a digital multipurpose signal 732 based on the radar waveform properties 626 and the reference signal parameters 730, as described above with respect to FIG. 7-1.

At 825, the first device 802 transmits the radar signal 310, as described above with respect to FIGS. 3 and 6-1. The radar signal 310 reflects off the object 180. The second device 804 receives a reflected version of the radar signal 310 (e.g., the reflected radar signal 332).

At 830, the second device 804 performs radar signal processing using receive deep-neural-network processing. For example, the deep neural network 614 of the radar signal receiver 604 uses the receive radar NN formation configuration 624 to generate radar data 632 based on the digital reflected radar signal 630, as described above with respect to FIG. 6-1. Sometimes, the second device 804 supports concurrent cooperative bistatic radar sensing and wireless communication. In this situation, the deep neural network 714 of the multipurpose signal receiver 704 uses the receive radar and communication NN formation configuration 728 to generate the radar data 632 and recover the reference signal parameters 730 as the reference signal parameters 736, as described above with respect to FIG. 7-1.

At 835, the second device 804 performs signal generation using transmit deep-neural-network processing. For example, the deep neural network 638 of the feedback signal transmitter 634 uses the transmit feedback NN formation configuration 654 to generate the digital feedback signal 658 based on the radar data 632, as described above with respect to FIG. 6-2. Sometimes, the second device 804 supports concurrent cooperative bistatic radar sensing and wireless communication. In this situation, the deep neural network 742 of the multipurpose feedback signal transmitter 738 uses the transmit feedback NN formation configuration 760 to generate the digital multipurpose feedback signal 766 based on the radar data 632 and the reference signal parameters 764, as described above with respect to FIG. 7-2.

At 840, the second device 804 transmits the feedback signal 340, as described above with respect to FIGS. 3 and 6-2. The second device 804 can use a same or different frequency band as the radar signal 310 to transmit the feedback signal 340. The first device 802 receives the feedback signal 340.

At 845, the first device 802 performs signal processing using receive deep-neural-network processing. For example, the deep neural network 646 of the feedback signal receiver 636 uses the receive feedback NN formation configuration 656 to generate object data 662 based on the digital feedback signal 660. Sometimes, the first device 802 supports concurrent cooperative bistatic radar sensing and wireless communication. In this situation, the deep neural network 750 of the multipurpose feedback signal receiver 740 uses the receive feedback NN formation configuration 762 to generate the object data 662 and recover the reference signal parameters 764 as the reference signal parameters 770.

The control and feedback signals (e.g., the configuration message 806, the availability message 812, the activation message 816, and the feedback signal 340) can occur in a frequency band that is different from a frequency band associated with the radar signal 310. For example, the frequency band for the control and feedback signals can be a sub-6 GHz frequency band, and the frequency band for the radar signal 310 can be in a frequency band associated with millimeter wavelengths (e.g., include frequencies greater than 6 GHZ, 30 GHZ, or 100 GHz).

### Example Methods

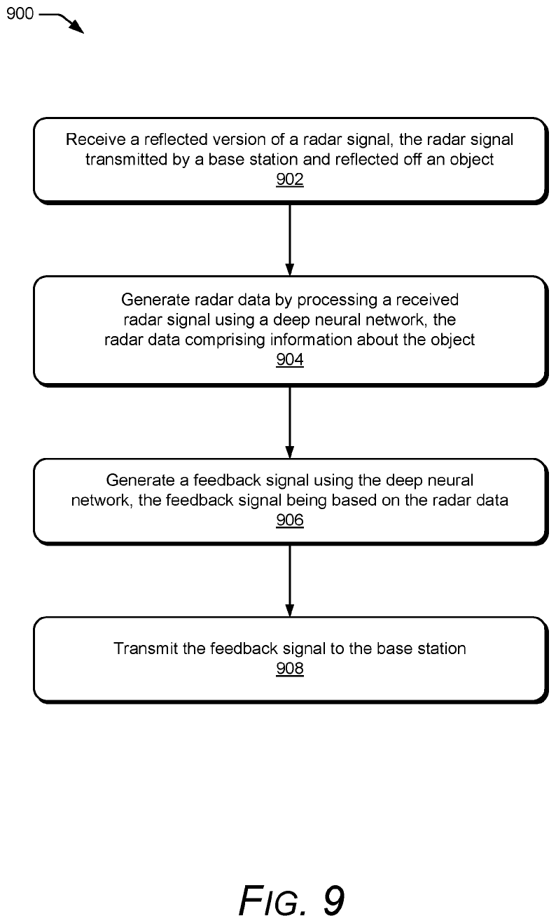

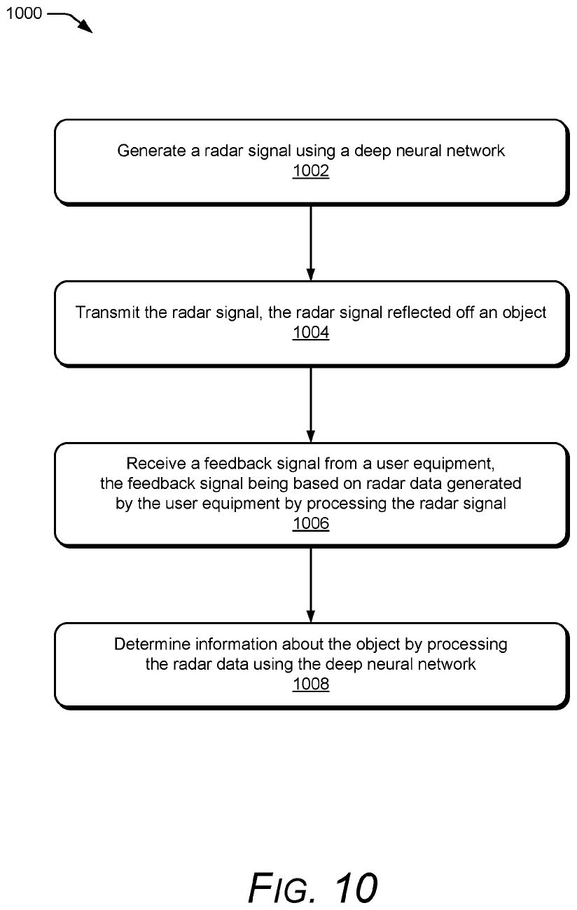

FIGS. 9 and 10 depict example methods 900 and 1000 for performing operations of cooperative bistatic radar sensing using deep neural networks. In portions of the following discussion, reference may be made to the environments 200 and 300 of FIGS. 2 and 3, and entities detailed in FIG. 1, 4, or 8, reference to which is made for example only. The techniques are not limited to performance by one entity or multiple entities operating on one device. For purposes of this example, a base station will perform the method of a radar signal transmitter and a feedback signal receiver, and one or more user equipment will perform the method of a radar signal receiver and a feedback signal transmitter. In other implementations, however, a user equipment performs the method of a radar signal transmitter and a feedback signal receiver, and at least one base station performs the method of a radar signal receiver and a feedback signal transmitter.

At 902 in FIG. 9, a user equipment receives a reflected version of a radar signal. The radar signal is transmitted by a base station and reflects off an object. For example, the user equipment 110 receives the reflected radar signal 332, which represents a reflected version of the radar signal 310, as shown in FIG. 3. The radar signal 310 reflects off the object 180. As an example, the user equipment 110 can represent the user equipment 112 or 113 shown in FIG. 2, and the object 180 can represent the object 183. In this case, the radar signal 310 traverses the propagation paths 224 or 228. The user equipment 110 can also receive the radar signal 310 via line-of-sight propagation.

At 904, the user equipment generates radar data by processing a received radar signal using a deep neural network. The radar data includes information about the object. For example, the user equipment 110 generates the radar data 632 by processing the reflected radar signal 332 using the deep neural network 614 of the radar signal receiver 604, as shown in FIG. 6-1. The user equipment 110 can also process the radar signal 310 directly and use the line-of-sight radar signal 310 to demodulate the reflected radar signal 332.

The radar data 632 can include implicit or explicit information about the object 180. For example, the radar data 632 can include raw digital samples of the digital reflected radar signal 630, which includes a phase that is based on the position of the object 180, a frequency that is based on the movement of the object 180, and an amplitude that is based on both the position of the object 180 and a material composition of the object 180. As another example, the radar data 632 can include processed information about the digital reflected radar signal 630, such as amplitude and/or phase information, complex range-Doppler maps, or interferometry data. Additionally or alternatively, the radar data 632 can include explicit information about the object 180, such as position information, movement information, size information, or material composition information.

At 906, the user equipment generates a feedback signal using the deep neural network. The feedback signal is based on the radar data. For example, the user equipment 110 generates the feedback signal 340 using the deep neural network 638 of the feedback signal transmitter 634, as shown in FIG. 6-2. The deep neural network 638 used to generate the feedback signal 340 can be the same as the deep neural network 614 used to process the reflected radar signal 332 or a separate deep neural network. The feedback signal 340 is based on the radar data 632. In some cases, the feedback signal 340 can include the radar data 632.

At 908, the user equipment transmits the feedback signal to the base station. For example, the user equipment 110 transmits the feedback signal 340 to the base station 120, as shown in FIGS. 3, 6-2, and 8.

At 1002 in FIG. 10, the base station generates a radar signal using a deep neural network. For example, the base station 120 generates the digital radar signal 628 using the deep neural network 606 of the radar signal transmitter 602, as shown in FIG. 6-1. In particular, the base station 120 generates the digital radar signal 628 based on the radar waveform properties 626.

At 1004, the base station transmits the radar signal, which reflects off an object. For example, the base station 120 transmits the radar signal 310, as shown in FIGS. 3, 6-1, and 8. The radar signal 310 can be a frequency-modulated signal or a phase-modulated signal. The radar signal 310 reflects off the object 180, as shown in FIG. 3.

At 1006, the base station receives a feedback signal from a user equipment. The feedback signal being based on radar data generated by the user equipment by processing the radar signal. For example, the base station 120 receives the feedback signal 340 from the user equipment 110. The feedback signal 340 includes the radar data 632 generated by the user equipment 110 based on the radar signal 310 (e.g., based on the reflected radar signal 332). The radar data 632 includes implicit or explicit information about the object 180.

At 1008, the base station determines information about the object by processing the radar data using the deep neural network. For example, the base station 120 generates the object data 662 by using the deep neural network 646 of the feedback signal receiver 636 to process the radar data 632 within the feedback signal 340. The object data 662 includes explicit information about the object 180, such as position information, movement information, size information, and/or material composition information.

Methods 900 and 1000 are shown as sets of operations (or acts) performed but not necessarily limited to the order or combinations in which the operations are shown herein. Further, any of one or more of the operations may be repeated, combined, reorganized, skipped, or linked to provide a wide array of additional and/or alternate methods.

### CONCLUSION

Although techniques using, and apparatuses including, cooperative bistatic radar sensing using deep neural networks have been described in language specific to features and/or methods, it is to be understood that the subject of the appended claims is not necessarily limited to the specific features or methods described. Rather, the specific features and methods are disclosed as example implementations of cooperative bistatic radar sensing using deep neural networks.

Some examples are provided below:

Example 1: A method performed by a first device, the method comprising:
operating as a radar signal receiver of a bistatic radar, the operating comprising:
   receiving a reflected version of a radar signal, the radar signal transmitted by a second device associated with a transmitter of the bistatic radar and reflected off an object; and
   generating radar data by processing the reflected version of the radar signal using a deep neural network, the radar data comprising information about the object; and operating as a feedback signal transmitter, the operating comprising:
   generating a feedback signal using the deep neural network, the feedback signal being based on the radar data; and
   transmitting the feedback signal to the second device.

Example 2: The method of example 1, wherein:
the deep neural network comprises a first deep neural network and a second deep neural network;
the generating of the radar data comprises generating the radar data using the first deep neural network; and
the generating of the feedback signal comprises generating the feedback signal using the second deep neural network.

Example 3: The method of example 1 or 2, wherein the generating of the feedback signal comprises:
accepting, by the deep neural network, the radar data; and
generating, by the deep neural network, digital samples based on the radar data, the digital samples associated with the feedback signal.

Example 4: The method of any previous example, wherein the radar data comprises at least one of the following:
raw digital samples of the reflected version of the radar signal;
range-Doppler maps; or
interferometry data.

Example 5: The method of any previous example, wherein the radar data comprises at least one of the following:
position information associated with the object;
movement information associated with the object;
size information associated with the object; or
material composition information associated with the object.

Example 6: The method of any previous example, wherein:
the feedback signal further indicates at least one of the following:
   a position of the first device;
   a velocity of the first device;
   an orientation of the first device; or
   an antenna configuration of the first device.

Example 7: The method of any previous example, further comprising:
modulating a reference signal onto the feedback signal; or
modulating the feedback signal onto the reference signal.

Example 8: The method of example 7, wherein:
the reference signal comprises an uplink reference signal or a downlink reference signal.

Example 9: The method of example 8, wherein:
the reference signal comprises the uplink reference signal; and
the uplink reference signal comprises a sounding reference signal.

Example 10: The method of example 8, wherein:
the reference signal comprises the downlink reference signal; and
the downlink reference signal comprises a primary synchronization signal, a secondary synchronization signal, a demodulation reference signal, a phase-tracking reference signal, a channel-state-information reference signal, or a tracking reference signal.

Example 11: The method of any previous example, further comprising:
receiving a configuration message from the second device, and
modifying an neural network formation configuration of the deep neural network based on the configuration message.

Example 12: The method of any previous example, wherein:
the radar signal is associated with a first frequency band; and
the transmitting of the feedback signal comprises transmitting the feedback signal using a second frequency band that is different than the first frequency band.

Example 13: The method of any previous example, wherein:
the transmitting of the feedback signal comprises transmitting the feedback signal using an assigned timeslot.

Example 14: A method performed by a first device, the method comprising:
operating as a radar signal transmitter of a bistatic radar, the operating comprising:
   generating a radar signal using a deep neural network; and
   transmitting the radar signal, the radar signal reflected off an object; and
operating as a feedback signal receiver, the operating comprising:
   receiving a feedback signal from a second device, the feedback signal being based on radar data generated by the second device by processing the radar signal; and
   determining information about the object by processing the radar data using the deep neural network.

Example 15: The method of example 14, wherein:
the deep neural network comprises a first deep neural network and a second deep neural network;
the generating of the radar signal comprises generating the radar signal using the first deep neural network; and
the determining the information about the object comprises determining the information by processing the radar data using the second deep neural network.

Example 16: The method of claim 14 or 15, wherein:
the generating of the radar signal comprises:
   accepting, by the deep neural network, at least one radar waveform property;
   generating, by the deep neural network, digital samples based on the at least one radar waveform property; and
   generating the radar signal using the digital samples.

Example 17: The method of claim 16, wherein:
the at least one radar waveform property comprises at least one of the following:
   a center frequency;
   a bandwidth:
   a pulse-repetition frequency;
   a beamforming configuration; or
   a modulation type.

Example 18: The method of any one of examples 14 to 17, further comprising:
modeling propagation paths within an operating environment based on the information about the object; and
adjusting beamforming configurations associated with wireless communication based on the modeled propagation paths.

Example 19: The method of any one of examples 14 to 18, further comprising:
modulating a reference signal onto the radar signal; or
modulating the radar signal onto the reference signal.

Example 20: The method of example 19, wherein:
the reference signal comprises an uplink reference signal or a downlink reference signal.

Example 21: The method of example 20, wherein:
the reference signal comprises the uplink reference signal; and
the uplink reference signal comprises a sounding reference signal.

Example 22: The method of example 20, wherein:
the reference signal comprises the downlink reference signal; and
the downlink reference signal comprises a primary synchronization signal, a secondary synchronization signal, a demodulation reference signal, a phase-tracking reference signal, a channel-state-information reference signal, or a tracking reference signal.

Example 23: The method of any one of examples 14 to 22, further comprising:
selecting multiple devices, the multiple devices including the second device; and
transmitting an activation message to the multiple devices to enable the multiple devices to receive reflected versions of the radar signal and transmit respective feedback signals.

Example 24: The method of any one of examples 14 to 23, further comprising:
receiving a reflected version of the radar signal; and
determining additional information about the object by processing the reflected version of the radar signal using the deep neural network.

Example 25: The method of any one of examples 14 to 24, further comprising:
receiving a reflected version of the feedback signal; and
determining other additional information about the object by processing the reflected version of the feedback signal using the deep neural network.

Example 26: A device comprising:
at least one antenna;
at least one transceiver;
at least one processor; and
at least one computer-readable storage media comprising instructions, responsive to execution by the processor, for directing the device to perform any one of the methods of examples 1 to 25.

Example 27: The device of example 26, wherein the device comprises a user equipment.

Example 28: The device of example 26, wherein the device comprises a base station.

Example 29: A computer-readable storage media comprising instructions that, responsive to execution by a processor, cause an apparatus comprising the processor to perform any one of the methods examples 1 to 25.

1. A method performed by a first device, the method comprising: operating as a radar signal receiver of a bistatic radar by
receiving a reflected version of a radar signal and generating radar data by processing the reflected version of the radar signal using a deep neural network, the radar signal transmitted by a second device associated with a transmitter of the bistatic radar and reflected off an object, the radar data comprising information about the object; and
operating as a feedback signal transmitter by
generating a feedback signal using the deep neural network transmitting the feedback signal to the second device, the feedback signal being based on the radar data.

2. The method of claim 1, wherein:
the deep neural network comprises a first deep neural network and a second deep neural network;
the generating of the radar data comprises generating the radar data using the first deep neural network; and
the generating of the feedback signal comprises generating the feedback signal using the second deep neural network.

3. The method of claim 1, wherein the generating of the feedback signal comprises:
accepting, by the deep neural network, the radar data; and
generating, by the deep neural network, digital samples based on the radar data, the digital samples associated with the feedback signal.

4. The method of claim 1, wherein:
the radar data comprises at least one of:
raw digital samples of the reflected version of the radar signal;
range-Doppler maps; or
interferometry data; and
information within the radar data comprises at least one of:
position information associated with the object;
movement information associated with the object;
size information associated with the object; or
material composition information associated with the object.

5. The method of claim 1, further comprising:
receiving a configuration message from the second device; and
modifying a neural network formation configuration of the deep neural network based on the configuration message.

6. The method of claim 1, wherein:
the radar signal is associated with a first frequency band; and
the transmitting of the feedback signal comprises at least one of:
transmitting the feedback signal using a second frequency band that is different than the first frequency band; or
transmitting the feedback signal using an assigned timeslot.

7. A method performed by a first device, the method comprising:
operating as a radar signal transmitter of a bistatic radar by
generating a radar signal using a deep neural network and
transmitting the radar signal, the radar signal reflected off an object; and
operating as a feedback signal receiver by
receiving a feedback signal from a second device and determining information about the object by processing the radar data using the deep neural network, the feedback signal being based on radar data generated by the second device by processing the radar signal.

8. The method of claim 7, wherein:
the deep neural network comprises a first deep neural network and a second deep neural network;
the generating of the radar signal comprises generating the radar signal using the first deep neural network; and
the determining the information about the object comprises determining the information by processing the radar data using the second deep neural network.

9. The method of claim 7, wherein:
the generating of the radar signal comprises:
accepting, by the deep neural network, at least one radar waveform property; and
generating, by the deep neural network, digital samples based on the at least one radar waveform property; and
generating the radar signal using the digital samples.

10. The method of claim 9, wherein:
the at least one radar waveform property comprises at least one of:
a center frequency;
a bandwidth;
a pulse-repetition frequency;
a beamforming configuration; or a modulation type.

11. The method of claim 7, further comprising:
modeling propagation paths within an operating environment based on the information about the object; and
adjusting beamforming configurations associated with wireless communication based on the modeled propagation paths.

12. The method of claim 7, further comprising:
selecting multiple devices, the multiple devices including the second device; and
transmitting an activation message to the multiple devices to enable the multiple devices to receive reflected versions of the radar signal and transmit respective feedback signals.

13. The method of claim 7, further comprising:
receiving a reflected version of the radar signal or a reflected version of the feedback signal; and
determining additional information about the object by processing the reflected version of the radar signal or the reflected version of the feedback signal using the deep neural network.

14. (canceled)

15. (canceled)

16. (canceled)

17. The method of claim 7, wherein:
the device comprises:
a user equipment; or
a base station.

18. The method of claim 7, further comprising:
modulating a reference signal onto the radar signal; or
modulating the radar signal onto the reference signal.

19. The method of claim 18, wherein:
the reference signal comprises an uplink reference signal or a downlink reference signal.

20. The method of claim 19, wherein:
the reference signal comprises the uplink reference signal; and
the uplink reference signal comprises a sounding reference signal.

21. The method of claim 19, wherein:
the reference signal comprises the downlink reference signal; and
the downlink reference signal comprises a primary synchronization signal, a secondary synchronization signal, a demodulation reference signal, a phase-tracking reference signal, a
channel-state-information reference signal, or a tracking reference signal.

22. The method of claim 1, wherein:
the device comprises:
a user equipment; or
a base station.

23. A network entity apparatus comprising:
a processor;
wireless communication hardware; and
computer-readable storage media storing instructions that, when executed by the processor, cause the processor and the wireless communication hardware to:
operate as a radar signal receiver of a bistatic radar by receiving a reflected version of a radar signal and generating radar data by processing the reflected version of the radar signal using a deep neural network, the radar signal transmitted by a second device associated with a transmitter of the bistatic radar and reflected off an object, the radar data comprising information about the object; and
operate as a feedback signal transmitter by generating a feedback signal using the deep neural network and transmitting the feedback signal to the second device, the feedback signal being based on the radar data.
